(19) United States
(12) Patent Application Publication
(10) Pub. No.: US 2024/0403428 A1
(43) Pub. Date: Dec. 5, 2024

(54) SYSTEM AND METHOD FOR UTILIZING LARGE LANGUAGE MODELS AND NATURAL LANGUAGE PROCESSING TECHNOLOGIES TO PRE-PROCESS AND ANALYZE DATA TO IMPROVE DETECTION OF CYBER THREATS

(71) Applicant: Darktrace Holdings Limited, Cambridge (GB)

(72) Inventors: Jake Lal, Cambridge (GB); John Boyer, Cambridge (GB)

(21) Appl. No.: 18/678,501

(22) Filed: May 30, 2024

Related U.S. Application Data
(60) Provisional application No. 63/470,571, filed on Jun. 2, 2023.
(60) Provisional application No. 63/472,227, filed on Jun. 9, 2023.

(51) Int. Cl. G06F 21/56; G06F 21/62

(52) U.S. Cl. CPC G06F 21/566; G06F 21/6245; G06F 2221/034

(57) ABSTRACT

A cybersecurity system for enhancing detection of cyber threats through use of one or more Large Language Models (LLMs) is described. Herein, the LLMs are configured to generate one or more structured elements that operate as a complex filter for automatically extracting salient data from data received from one or more external sources for training of Artificial Intelligence (AI) models. Additionally, the LLMs are further configured to correlate multiple user credentials associated with different platforms to identify a common user to enhance training of the AI models and anonymize at least personally identifiable information (PII) data prior to training of the AI models.

### RELATED APPLICATION

This application claims priority under 35 USC 119 to U.S. Provisional Patent Application No. 63/470,571, titled “CYBERSECURITY SYSTEM” filed Jun. 2, 2023, and U.S. Provisional Patent Application No. 63/472,227, titled “A CYBERSECURITY SYSTEM” filed Jun. 9, 2023, where the entire contents of these applications are incorporated by reference herein.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Cybersecurity and in an embodiment use of Artificial Intelligence in cybersecurity.

### BACKGROUND

Cybersecurity attacks (hereinafter, “cyberattacks”) have become a pervasive problem for enterprises as many computing devices and other resources have been subjected to attack and compromised. A “cyberattack” constitutes a threat to security of an enterprise, which may be broadly construed as an enterprise network, one or more computing devices connected to the enterprise network, stored or in-flight data accessible over the enterprise network, and/or other enterprise-based resources. This cybersecurity threat (hereinafter, “cyber threat”) may involve a malicious or criminal action directed to an entity (e.g., enterprise, individual, group, etc.) such as introducing malware (malicious software) into the enterprise. Originating from an external endpoint or an internal entity (e.g., a negligent or rogue authorized user), the cyber threat may range from theft of user credentials to even a nation-state attack, where the actor initiating or causing the security threat is commonly referred to as a “malicious” actor. Conventional cybersecurity products are commonly used to detect and prioritize cyber threats against the enterprise, and to determine preventive and/or remedial actions for the enterprise in response to those cyber threats.

Currently, unstructured data is gathered from third party sources and ingested by a cybersecurity system. Thereafter, a human analyst reviews the unstructured data and categorizes the unstructured data. This may involve the human analyst allocating portions of the unstructured data into different data structures, each data structure is associated with a different data category. As a result, by categorizing the data, structured data is produced, where the structured data may be used as training data for one or more Artificial Intelligence (AI) models. However, given that the categorization of the unstructured data is based on human activity, the transformation of the unstructured third-party data into structured data cannot be performed quickly or reliably, as human analysts may, at times, fail to collect salient or meaningful data for a specific customer that would improve cyber threat detection and/or assists in the creation of new detection tools and/or AI detection models for that customer.

Additionally, conventional technologies within a cybersecurity system are unable to monitor, autonomously without human intervention and in real time, the health of AI detection models that are relied upon to detect a model breach. The lack of automated monitoring of AI detection model health has led to inferior threat detection operability along with increased labor costs as cyber technologists must be hired to review the AI detection models and adjust (tune) them based on changes in threat landscape and/or potential model misconfigurations (or ineffective configurations).

Furthermore, conventional technologies within a cybersecurity system are unable to detect and correlate different user names utilized by the same user over multiple platforms. This lack of detection and correlation prevents the cybersecurity system from leveraging this data to establish normal versus abnormal user behavior to detect cyber threats to an enterprise unless an unacceptable amount of human resources are allocated to access and analyzed other network environments for each targeted user of the enterprise.

Lastly, the conventional technologies are not configured to conduct anonymization of personally identifiable information (PII) and other sensitive information. Such anonymization is necessary to generate training data for use by tuning the functionality of the AI detection models.

### SUMMARY

Methods, systems, and apparatus are disclosed for an AI-based cybersecurity system deploying generative AI logic adapted to conduct pre-processing of incoming data to convert the incoming, unstructured data into anonymized, structured data. The generative AI logic is further configured to create or adjust AI models to enhance cyber threat detection by the AI-based cybersecurity system.

Accordingly, one inventive aspect of the disclosure may be broadly described as a method for enhancing detection of cyber threats by a cybersecurity system through use of one or more Large Language Models (LLMs). The method comprises a plurality of operations, including some or all of the following: (1) generating a first embedding vector based on content within a first data set, wherein the first data set includes at least a first user credential; (2) generating a second embedding vector based on content within a second data set, wherein the second data set includes at least a second user credential; (3) identifying a user is associated with both the first user credential and the second user credential based on a level of correlation between the first embedding vector and the second embedding vector exceeding a prescribed value; and (4) training an Artificial Intelligence (AI) model using both the content within the first data set and the content within the second data set to improve detection of cyber threats associated with data pertaining to the user.

Additionally, another inventive aspect of the disclosure may be broadly described as a cybersecurity system that features multiple large language models (LLM) to enhance cyber threat detection. As an illustrative example, these LLMs may include some or all of the following: (1) a first LLM configured to generate one or more structured elements that operate as a complex filter for automatically extracting salient data from data received from one or more external sources for training of one or more Artificial Intelligence (AI) models; (2) a second LLM configured to correlate multiple user credentials associated with different platforms to a common user to enhance training of the one or more AI models formerly trained with data associated with the common user as identified by a first user credential with additional data associated with a second user credential to enhance cyber threat analytics pertaining to activities by the common user; and (3) a third LLM configured, upon execution, to anonymize at least personally identifiable information (PII) data prior to training of the one or more AI models.

These and other features of the design provided herein can be better understood with reference to the drawings, description, and claims, all of which form the disclosure of this patent application.

### BRIEF DESCRIPTION OF THE DRAWINGS

The drawings refer to some embodiments of the design provided herein in which:

FIG. 1 is an illustrative logical representation of an AI-based (AI-based) pre-processing component configured to include or with access to one or more Large Language Models (LLMs) adapted to pre-process data into prescribed data structures as well as to create or adjust AI detection models to improve cyber threat detection.

FIG. 2 is an illustrative physical representation of the AI-based pre-processing component of FIG. 1 configured to control operability of a cyber threat detection engine deployed within an AI-based cybersecurity appliance.

FIG. 3 is a block diagram of an embodiment of the AI-based cybersecurity appliance including components forming the cyber threat detection engine of FIG. 2 that protects an enterprise from cyber threats.

FIGS. 4A-4B are illustrative flowcharts of operations performed by the LLM(s) to store and correlate credentials for users of the enterprise to enhance cyber threat detection.

FIG. 4C is an illustrative flow of the operations performed by one or more LLMs configured to conduct analytics for credential comparison as shown in FIG. 4B.

FIGS. 5A-5B are illustrative block diagrams of an embodiment of a model adjustment component configured to create or adjust AI detection models to improve cyber threat detection.

FIG. 6 illustrates a block diagram of an embodiment of the cyberattack simulation engine of FIG. 1 with AI-based simulations conducted in the cyberattack simulation engine by constructing a graph of nodes of an enterprise or computing device being protected.

FIG. 7 illustrates a diagram of an embodiment of a cyberattack simulation engine and its AI-based simulations constructing a graph of nodes in an example network and simulating how the cyberattack might likely progress in the future tailored with an innate understanding of a normal behavior of the nodes in the system being protected and a current operational state of each node in the graph of the protected system during simulations of cyberattacks.

FIG. 8 illustrates a block diagram of an embodiment of the AI-based cybersecurity appliance featuring AI-based engines of FIG. 1.

FIG. 9 illustrates a graph of an embodiment of an example chain of unusual behavior for, in this example, the email activities and IT network activities deviating from a normal pattern of life in connection with the rest of the system/network under analysis.

FIG. 10 illustrates a block diagram of an embodiment of a computing device that can be a part of the AI-based cybersecurity system including the multiple AI-based engines discussed herein.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details are set forth, such as examples of specific data signals, named components, or the like, in order to provide a thorough understanding of the present design. It will be apparent, however, to one of ordinary skill in the art that the present design can be practiced without these specific details. Hence, well known components or methods have not been described in detail or displayed in a block diagram in order to avoid unnecessarily obscuring the present design. While specific numeric references, such as a first Large Language Model (LLM), have been made, these specific numeric references should not be interpreted as a literal sequential order but rather interpreted that the first LLM may be different, physically or in operation, from a second LLM. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

### I. General AI-Based Cybersecurity System Summary

Herein, an AI-based (AI-based) cybersecurity system is described. The AI-based cybersecurity system includes several components configured to communicate and cooperate with each other, including a cybersecurity appliance implemented with a cyber threat detection engine, a cyber threat autonomous response engine, a cyberattack simulation engine, a cyberattack restoration engine, and other components such as one or more large language models (hereinafter, “LLM(s)”). For example, the LLM(s) and natural language processing (NLP) logic may be configured to (i) pre-process data into a format that assists or improves cyber threat detection (e.g., increase the likelihood of successful detection of a cyber threat when present) and/or (ii) conduct analytics on the detected cyber threats to adjust functionality of existing AI detection models or create new AI detection models based. The adjusted and/or created AI detection models may be configured with an open standard file format such as a JavaScript™ Object Notation (JSON) format.

Herein, a LLM can be one or more AI-based algorithms that have been trained on a large amount of text-based data, typically scraped from the publicly available resource such as Internet-based sources such as webpages, published scientific research, books, forums or social media posts. Generative AI logic, such as LLM(s) for example, can be an AI system (or portions thereof) configured to generate new content (e.g., images, music, speech, code, video, text, etc.). The LLM(s) (e.g., GPT-3™, PaLM™ or LLaMA™) can be the underlying technology behind many powerful generative AI systems today (e.g., ChatGPT™, Bard™).

As described below, the cybersecurity system may be configured with a pre-processing component with one or more LLMs (and the associated generative AI-creating algorithms) to generate new content based on information learned from existing data. As described below, the AI-based cybersecurity system may be configured with a pre-processing component that features LLM(s) to (i) pre-process data into a format that assists or improves cyber threat detection and/or (ii) conduct analytics on information associated with model breach alerts to potentially adjust existing AI detection models or create new AI detection models based on the analytics. The AI-based cybersecurity system can be implemented with an LLM positioned in front of the cyber threat detection engine to mitigate any potential cyberattack and assist the cyber threat detection engine in making informed decisions as to what data may constitute a potential cyberattack and how to adjust/create a new AI model.

Additionally, or in the alternative, the pre-processing component may be implemented with one or more LLMs in communication with the cyber threat detection engine, the cyber threat autonomous response engine, the cyberattack simulation engine, and/or the cyberattack restoration engine. Additionally, or in the alternative, the one or more LLMs may be deployed as components within the cyber threat detection engine, the cyber threat autonomous response engine, the cyberattack simulation engine, and/or the cyberattack restoration engine.

The AI-based cybersecurity system can make use of LLMs that perform human language identification for automatic translation of content within the user interface, enabling localization and generation of suggested Natural Language Processing (NLP) format of the steps needed to conduct mitigation and/or remediation to reduce risk in the cloud component and/or the general network environment. The LLMs of the cybersecurity system are configured to perform many additional tasks as discussed herein.

Thus, for example, the LLMs can be utilized to suggest remediation actions in the aftermath of cyberattacks, such as a change (or addition) to aid in mitigating ongoing attacks by making informed decisions, function as first-line support for client queries, explain AI decision processes in cybersecurity platforms, summarize and prioritize breaches, assist in querying detailed log data, provide recommendations based on breach summaries and threat trends, and/or generate code for data visualizations. Furthermore, an open standard file format (JSON) document with complex filters may be created. By leveraging the capabilities of LLMs, organizations can strengthen their cybersecurity defenses and improve response mechanisms to counter advanced persistent threats effectively.

Thus, LLMs can be employed in conjunction with the cyber threat detection engine (described below), enabling informed decision-making to improve detection of cyber threats during an ongoing cyberattack based on autonomously formed training data based on raw, unstructured data from a third-party source and leveraging the LLM's knowledge and expertise. Herein, the LLM(s) may be configured to pre-process data into formats that improve future cyber threat detection through various LLM actions such as (1) creating JSON elements and complex filters, (2) detecting and aggregating content associated with users with similar usernames or presence across different platforms (e.g., networks, cloud resources, etc.) for reliance in cyber threat analytics, and/or (3) anonymizing personally identifiable information (PII) and other sensitive information within the data supplied by the third-party prior to training.

Moreover, by training an LLM to act as a first line of support, clients can receive assistance in understanding cybersecurity products and troubleshooting issues they may encounter. Additionally, the LLM can provide valuable cyber analyst answers, shedding light on various cybersecurity techniques and the current threat landscape. Furthermore, organizations can harness the capabilities of LLMs by providing them with Application Programming Interface (API) specifications, enabling the LLM to understand how to make API requests and translate user questions into API queries within an AI-based cybersecurity platform. This functionality helps explain the decision-making process of the AI system, enhancing transparency and trust.

Additionally, or in the alternative, the LLM(s) may be further configured to modify existing AP models or create new AI detection models, which may be in a JSON format, based on at least one model breach alert. A “model breach alert corresponds to a determination that a set of conditions (logical criteria), represented by the JSON data structure of the AI detection model, has been met to denote that an event or a series of events violates one or more AI detection models and may be associated with a cyber threat. This may be accomplished by the LLM(s), operating as a model health analyzing component without hardcoded solutions, analyzing and aggregating breach context data, namely (i) the model breach alert and its triggers, (ii) information about the events and/or computing device(s) involved in its model breach alert, (iii) potential reasons for the model breach alert, and/or (iv) data pertain to the AI detection model associated with the model breach alert. This breach context data aids in effective breach detection and resource allocation.

The advent of LLMs has opened up new possibilities in bolstering cybersecurity practices. For example, the cybersecurity system can use LLM(s), operating as the model health analysis component, to provide the breach context data to a model refinement component. Based on the breach context data, the model refinement component is configured to determine one or more suggest adjustments to an existing AI detection models and/or generate new AI detection models without human intervention.

Furthermore, LLMs can be trained to generate software code that creates data visualizations, such as graphs and charts, showcasing cybersecurity breaches, user activity, and current cyber threat trends. This capability simplifies the presentation of complex data, enabling stakeholders to grasp key insights quickly.

In conclusion, through the utilization of LLMs, organizations can enhance their cybersecurity measures, effectively defend against advanced threats, and strengthen their overall resilience in the face of evolving cyber threats.

### II. LLM Functionality

### A. Intelligent Search and API-LLM Explaining AI Decision Process in Cybersecurity Platforms

By providing an LLM with an API specification, organizations can enhance the transparency of AI-based cybersecurity platforms. The LLM can interpret user queries, translate them into API queries, and then explain how the AI-based cybersecurity system arrives at its decisions. This functionality enables users to understand the reasoning behind the capabilities of the AI-based recommendations or actions. It also helps build trust and confidence in the capabilities of the AI-based cybersecurity system, as users can gain insights into the decision-making process and validate the system's outputs.

By providing the LLM with an API specification an LLM can understand how to make API requests and translate questions into API queries.

The user interfaces into the different components of the cybersecurity system can use the AI to enhance how customers can interact with these products in natural language. This also allows for a natural language interaction with the cybersecurity product/platform. For example, a prompt may include “[g]iven our API docs find me all devices that communicated over TCP in the last 4 days.”

### B. Summarizing and Prioritizing Breaches

When provided with a list of model breaches and their triggers, an LLM can generate a summary and prioritize them based on specified parameters. For example, the LLM can consider the severity of the model breach, the impact on critical systems or data, and the potential risk to the enterprise. By prioritizing model breaches, organizations can allocate their resources more effectively, focusing on addressing the most critical incidents first. The LLM's analysis assists in streamlining breach response efforts and minimizing further damage as well as adjusting existing AI detection models and/or creating new AI detection models that would have uncovered the certain cyber threats or reduced over-breaching.

For example, as a prompt, the organization may provide the LLM with a list of all model breaches and their triggers then ask the LLM to provide a summary and prioritization of the breaches based on the parameters known about those breaches. For example, the prompt may state-“given there are 40 Breaches of moderate severity (e.g., score 60) for prescribed events that are new for the user, for users x, y, z at times a/b/c, provide me with a summary, any possible links between breaches, and also prioritize the order in which I should triage them.”

The LLM would be trained on the cybersecurity API and be aware of where information can be found, what kind of data each endpoint returns, and the data the cybersecurity AI Analyst considers relevant for similar activity.

### C. LLM Created AI Detection Model

The cybersecurity system can provide the LLM with a list of all statuses from cybersecurity modules and components (via APIs) and ask it to summaries the health of the deployment. On average we see traffic at a rate of 20000 events/s, then for example, 1 out of 20 SaaS modules have an error status and have been in that state for 2 weeks.

The LLM(s) may be configured to summarize the health of the deployed AI detection models and what can do to resolve “unhealthy” AI detection models.

### D. Natural Language Interface for the Cybersecurity Advanced Search

The cybersecurity system can query detailed log data in a human-speech way. Training an LLM on the search syntax for tools like the cybersecurity Advanced Search allows users to query detailed log data in a more user-friendly manner. Instead of learning complex search syntax, users can express their queries in natural language, making log analysis more accessible and efficient. The LLM understands the intent behind the query and translates it into the appropriate search syntax, simplifying the process of extracting relevant log information for investigations or threat hunting.

An LLM approach is trained on the search syntax for the cybersecurity Advanced Search, allowing users to query for detailed log data in a friendly human-speech way. This would be combined with training on the usual “questions” users ask—i.e., searches—to allow the interface to suggest the next steps in a friendly way.

### E. Producing Summary Reports and Recommendations

The cybersecurity system can provide breach summaries and recommendations. By feeding an LLM with historical cybersecurity breaches, severity scores, and current threat trends, organizations can generate breach summaries and receive recommendations. The LLM can analyze patterns, identify common vulnerabilities, or attack vectors, and provide actionable insights to improve system security. These recommendations can include implementing specific security controls, conducting vulnerability assessments, or enhancing user awareness through targeted training. The LLM's analysis empowers organizations to proactively strengthen their security defenses.

Feed an LLM the history of cybersecurity breaches/models breaches and their severity scores as well as current cyber threats trending currently (e.g., model breaches/respond/AI analyst) and have the LLM produce both a summary of these breaches and trends as well as to provide recommendations to help a user of a cybersecurity appliance to improve their system in light of the current model breaches and cyber threat trends. E.g., example prompts:
Given that this month we have seen the following autonomous response actions: [block IP 1, block IP 2, block user 3, block user 4] produce me some security recommendations.
An example might be to fully block certain IP ranges and conditional access policies to the users.
Summarize John Boy's office365 SaaS events for the last week and decide if his current permissions set which is [X Y Z] is appropriate or whether they can be reduced.

### F. Produce Customized Data Visualizations

The cybersecurity system can generate code for data visualizations. Training an LLM to generate software code for creating data visualizations related to cybersecurity breaches, user activity, and threat trends can automate the process of generating informative visuals. The LLM can interpret the desired visualization requirements and generate code snippets in programming languages like Python™ or JavaScript™. This capability simplifies the creation of graphs, charts, or interactive dashboards, enabling security analysts and stakeholders to visualize and comprehend complex data in a more intuitive manner.

LLMs can retrieve data and write code, given a good enough specification. For an LLM pre-trained on the cybersecurity API, it can create (and implement) code to produce visualization based upon a natural language prompt. For example: “Produce me a bar graph that breaks down a user's activity over the last week, including sub-sections of the column breaking down the source IP.”

III. Creating Custom Modules, Log Ingestion, and Models with an LLM
A. Creating JSON Elements with Complex Filters

An LLM can be leveraged to create JSON elements with complex filters, facilitating advanced data processing and analysis in cybersecurity workflows. A LLM is capable of creating JSON elements with complex filters, provided a well-defined schema is established for the JSON element where data within certain fields of the JSON element may be inferred when not supplied. For instance, the LLM can generate filters based on specific criteria, such as specific times or periods of time, a specific IP address or IP address range, specific attack signatures (e.g., specific patterns of network traffic, email content or code segments, specific packet header content, specific commands or keywords, specific points of access attempts, etc.). These JSON elements can then be used to filter and extract relevant data from large data sets, which may be further analyzed for association with a known cyberthreat.

### B. Models

The cybersecurity system has trained an LLM to create models for the cybersecurity Cloud Security product. The cybersecurity system pre-prompts the LLM with training material on how the model is formed, the meaning of each field, how to construct Boolean logic, and some worked examples.

After, it can demonstrably create new examples given a natural language description of the type of activity we wish to target.

### C. Log Ingestion

The cybersecurity telemetry data uses regular expression pattern analytics to parse fields. Pre-prompted with a defined specification, such as example parsing templates, example regular expression patterns (e.g., GROK patterns) and log pairs, the LLM can produce new templates when given example log entries.

### D. Modules

The format for event parsing and classification for SaaS/Cloud security modules is relatively standard. The classification of events into buckets such as “Admin,” “login,” and “File Created” is currently done manually. Third-party platforms also often provide detailed API specs of their available endpoints.

LLMs can therefore be trained on existing module structures and event classification to create new modules, given the API specification and—once authenticated—examples of events.

### IV. Additional LLM Cybersecurity Enhancement Functionality

The LLM may be trained on certificate information and responses (almost akin to a JA3 or similar attempts to “fingerprint”), then is fed data from the wider web to try and find examples of the same service it was trained on (i.e., that fit its predication).

The cybersecurity system can make use of intelligent user combinations across platforms (e.g., combining data associated with the users having similar usernames or presences across different platforms). LLMs can assist in this process by considering contextual data, such as roles, activity times, standard behaviors, and clustered peers. By providing all available information about both users, the LLM can assess whether it is appropriate to consider combining the information as being associated with the same user or not. This capability extends to devices by considering factors such as hostnames, active times, and locations. LLMs have the advantage of being able to process vast amounts of time-series data and make informed decisions, which can then be corrected by human input if necessary.

The system can combine users with similar usernames or presences back into a single user, when appropriate, without a human indicating they are the same. For example, is john@slammar the same user as john.b@slimmer, or are they two users with the same initials?

In an example, the LLM received as input contextual data available about both users (including roles, activity times, standard behaviors, clustered peers, etc.) and then assesses the likelihood of both usernames are associated with the same user.

This can be extended to devices by considering hostnames, active times, and locations—the power comes from it being able to use any information (e.g., vast amounts of time series data a human cannot comprehend) and decide which it cares about. If it is wrong, then a user can just tell it so and correct the output.

Additionally, LLMs such as a Bidirectional Encoder Representations from Transformers (BERT) language model for example, are pretrained on a large amount of linguistic data, and have a generic understanding of language that can be fine-tuned for a wide range of specific tasks. URIs are in some ways similar to natural language, containing a range of linguistic elements, but their syntax differs in several respects, meaning that limited results can be achieved by fine-tuning LLMs, and this fine-tuning must be redone for every URI-related task. By making a large dataset of URIs and related information (e.g., titles, page content), a LLM can be trained specifically on the patterns in URIs, creating a model with a generic semantic understanding of URIs, including e.g., that “somesite.com/training.mp4” likely relates to a video file, that “somesite.com/activate.php” will involve the execution of server-side code, or that “somesite.com/data?starttime=2021” relates to the extraction of filtered API data. This generic model can then be fine-tuned on a range of specific URI-related tasks, such as looking for malicious URI patterns, analyzing phishing links, or detecting C2 communication, providing more power and versatility.

The resulting model can encode URLs for search & classification across a huge range of tasks. This includes: (1) Identifying new threats by detecting common URI patterns; (2) categorizing threat types from their URL; (3) predicting if a URL is likely to be malicious; and (4) searching for similar threats by using their URLs.

### V. Detection and Anonymization of Personally Identifiable Information

The cyber security appliance can use an efficient detection and anonymization of personally identifiable information in semi-machine contexts. Many data privacy regulations introduce clear and restrictive rules of the types of actions that can be performed with “Personally Identifiable Information,” also known as “PII data.” There are multiple natural language processing technologies that can be applied to accurately detect PII data in natural language texts, e.g., email and other messaging services. However, these methods have their limitations, in terms of scalability and in terms of accuracy to process samples that clearly differ from typically natural texts.

Regarding scalability, the AI detection (NLP) models tend to be more accurate when they have access to higher volumes of training data, typically resulting in larger models. This in principle can be bypassed by locating these models in centralised spaces in the cloud where the data would be massively processed. However, this cannot be applied in many contexts involving strict data privacy regulations or other contractual agreements. It is often required a previous anonymization before this data is transported across the Internet.

It is therefore of interest a method that exploits the advantages of NLP in fast and efficiently detection and anonymization of PII data in scenarios with limited computational resources. This method combines various techniques to accurately anonymize PII data in semi-machine texts. The method features the following operations. First, transform semi-machine texts into more natural language texts, e.g., transforming strings such as user jane.doe, user jane_doe or user janedoe into strings of the form user Jane Doe. Second, process the resulting texts with public but small natural language models. Thereafter, anonymize the identified relevant PII data. Finally, reconstruct the resulting text into the original format.

In order to infer natural language strings that could be present in a machine-like string, a statistical approach based on word frequency is applied. The method uses a second statistical approach to accurately identify words and noun phrases typically related to computing and IT contexts, e.g., Kerberos Login, Login Session, etc. The method includes static filters to anonymize known PII strings that are provided a priori and various other rules to process clearly identifiable objects, e.g., URLs, email addresses, etc.

### VI. AI-Based Cybersecurity System Architecture

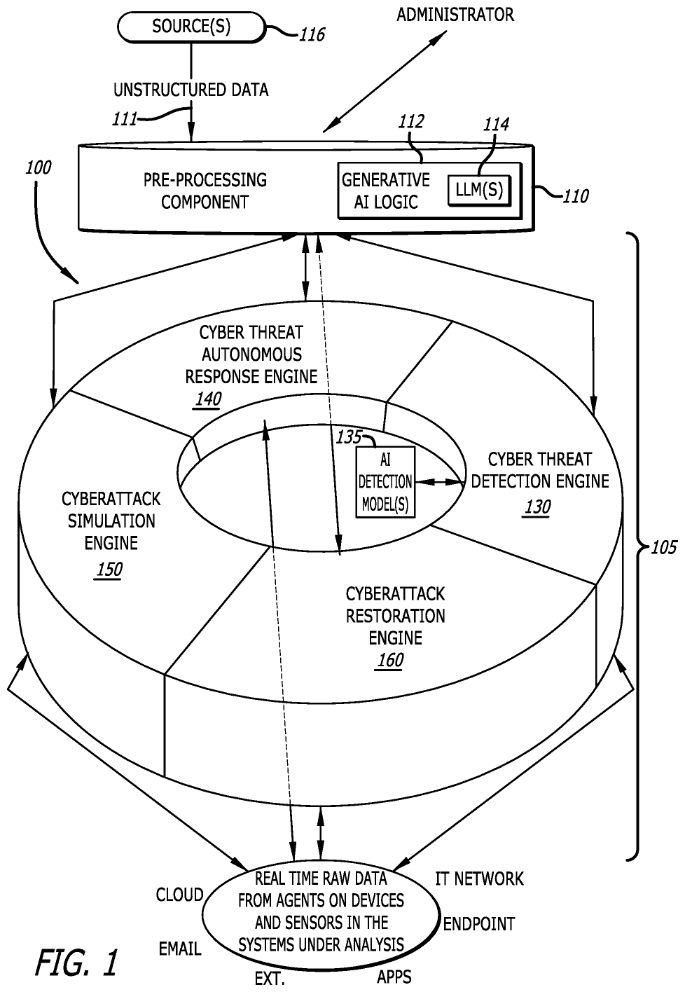

Referring to FIG. 1, an illustrative embodiment of an AI-based cybersecurity system 100 is shown. The AI-based cybersecurity system 100 features an AI-based cybersecurity appliance 105 in communication with a pre-processing component 110 adapted to receive and process data from one or more external sources 120. The cybersecurity appliance 105 features a cyber threat detection engine 130, a cyber threat autonomous response engine 140, a cyberattack simulation engine 150, and a cyberattack restoration engine 160.

According to one embodiment of the disclosure, the cyber threat detection engine 130 may be configured to conduct analytics on incoming data to detect whether a cyber threat, such as a potential cyberattack represented as an AI model breach for example, has occurred. Such analytics may be conducted by one or more AI algorithms deployed within or accessible to the cyber threat detection engine 130. Likewise, the cyber threat autonomous response engine 140 is configured to perform one or more actions to mitigate or eliminate the likelihood of a potential cyberattack based on a detected cyber threat. These actions may be performed by one or more trained AI algorithms deployed within or accessible to the autonomous response engine 140.

Additionally, the pre-processing component 110 may be further adapted to communicate with the cyberattack simulation engine 150 and the cyberattack restoration engine 160. The cyberattack simulation engine 150 is configured, using AI algorithms coded and trained to perform a ML task of AI-based simulations of cyberattacks to assist in determining 1) how a simulated cyberattack might occur in the AI-based cybersecurity system 100 being protected, and 2) how to use the simulated cyberattack information to preempt possible escalations of an ongoing actual cyberattack.

The cyberattack restoration engine 160 is configured to conduct actions to fix one or more cloud components for the AI-based cybersecurity system 100 thereby adjusting for any misconfigurations associated with these component(s). This may include altering settings, permissions, or stored information (e.g., addressing, data, etc.) within the component(s) or even returning the component(s) back to their trusted operational state. These remediation actions might be fully automatic or require a specific human confirmation decision before they begin. The cyberattack restoration engine 160 is further configured to cooperate with the other AI-based engines 130/140/150/160 of the cybersecurity appliance 105, via interfaces and/or direct integrations, to track and understand the cyber threat identified by the incoming (third-party) information and the other components as well as track the one or more actions to be undertaken to fix an AI model misconfiguration or to assist in intelligently restoring cybersecurity appliance 105 back to a trusted operational state.

For example, multiple AI-based engines, cooperating with each other, may include i) the cyber threat detection engine 130, ii) the cyber threat autonomous response engine 140, iii) the cyberattack simulation engine 150, and/or iv) the cyberattack restoration engine 160. The multiple AI-based engines have communication hooks in between them to exchange a significant amount of behavioral metrics including data between the multiple AI-based engines to work in together to provide an overall cyber threat response.

The pre-processing component 110 can be configured as a discreet component that exists on top of multiple AI-based engines 130/140/150/160 to orchestrate the overall cyber threat response and an interaction between the multiple AI-based engines, each configured to perform its own machine-learned task. Alternatively, the pre-processing component 110 can be configured as a distributed collaboration with a portion of the pre-processing component 110 implemented in each of the multiple AI-based engines 130/140/150/160 to orchestrate the overall cyber threat response and an interaction between the multiple AI-based engines. In an embodiment, whether implemented as a distributed portion on each AI engine or a discrete AI engine itself, the pre-processing component 110 can use self-learning algorithms to learn how to best assist the orchestration of the interaction between itself and the other AI-based engines, which also implement self-learning algorithms themselves to perform their individual machine-learned tasks better.

The multiple AI-based engines 130, 140, 150 & 160 each have an interface to communicate with the other separate AI-based engines configured to understand a type of information and communication that the other separate AI-based engine needs to make determinations on an ongoing cyberattack from that other AI-based engine's perspective. Each AI-based engine has an instant messaging system to communicate with a human cybersecurity team to keep the human cybersecurity team informed on actions autonomously taken and actions needing human approval as well as generate reports for the human cybersecurity team.

As shown in FIG. 1, the pre-processing component 110 may be configured with generative Artificial Intelligence (AI) logic 112 including one or more LLMs (LLM(s)) 114. The LLM(s) 114 may be structured as a single LLM, multiple (two or more) separate LLMs, and/or a nested LLM architecture in which an input of a second LLM is based, at least in part, on an output of a first LLM. According to one embodiment of the disclosure, the LLM(s) 114 may be configured to (i) pre-process data to improve the quality of cyber threat detections performed by or expand the ability of such detections and/or (ii) adjust functionality of existing cyber threat detection logic or create new cyber threat detection logic such as new AI detection models for example.

As an illustrative example, the pre-processing component 110 is configured to utilize the LLM(s) 114 to (i) create JSON elements with complex filters for extracting relevant and targeted data from large data sets; (ii) conduct analytics on contextual data for similar credentials, such as user credentials for example, across different platforms (e.g., usernames or other presences in different platforms and/or authentication data) to determine whether these credentials are associated with the same user; and/or (iii) conduct PII data anonymization. Additionally, or in the alternative, the LLM(s) 114 may be configured to ingest, in real time, information associated with model breach activity to assess the health of AI detection models 135 accessible to the cyber threat detection engine 130 of the cybersecurity appliance 105. If some or all of the AI detection models 135 are determined to be ‘unhealthy’ (e.g., misconfigured, operating with false positive or false negative scoring exceeding a prescribed threshold, etc.), the LLM(s) 114 generate information to adjust (tune) the unhealthy AI detection models 135 to improve cyber threat detection functionality or generate a new AI detection model to substitute for an unhealthy AI detection model.

Herein, the pre-processing component 110 may be configured to pre-process data provided to at least a cyber threat detection engine 130 of the cybersecurity appliance 105. Although, it is contemplated that the pre-processing component 110 may be configured to pre-process data provided to the cyber threat autonomous response engine 140, the cyberattack simulation engine 150, and/or the cyberattack restoration engine 160 deployed within the cybersecurity appliance 105.

More specifically, the pre-processing component 110 is configured to receive unstructured information 111 associated with a current cyber threat detected externally from the AI-based cybersecurity system (hereinafter, the “unstructured data set”). The unstructured data set 111 associated with the threat landscape is received from one or more sources 116 external from the AI-based cybersecurity system 100 such as open source cyberthreat intelligence, social media information, and/or news website information for example. Herein, according to this embodiment of the disclosure, the pre-processing component 110 includes the LLM(s) 114 that are trained to create JSON elements with complex filters, which facilitate advanced data processing and analysis in cybersecurity workflows.

For instance, as an illustrative example, the LLM(s) 114 can generate JSON elements performing as filters that operate in accordance with specific criteria, such as timeframes, source IP addresses, or specific attack signatures as described above. These JSON elements are used to filter and extract relevant data from large data sets (e.g., the unstructured data set 111) for further analysis using other tools or platforms accessible via the pre-processing component 110. The functionality of the LLM(s) 114 to generate complex filters provides the AI-based cybersecurity system 100 with an operational advantages by (i) simplifying the data processing pipeline through faster integration (AI detection model training) with third-party source data and (ii) enhancing the efficiency of cybersecurity operations through intelligent and targeted gathering of salient data to improve and/or expand cyber threat detection functionality supported by the cyber threat detection engine 130.

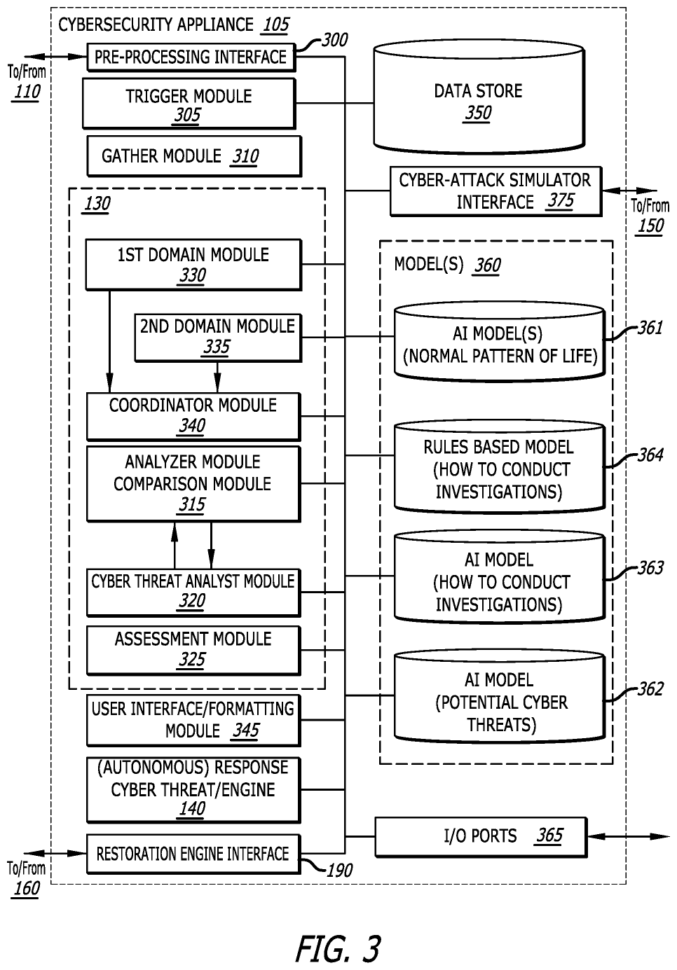

Herein, one or more modules within the AI-based cybersecurity system 100 may utilize GROK patterns to alter the received unstructured data set 111 into a field-based structured data set. In particular, the GROK patterns use regular expressions to match patterns in the unstructured data set 111. Upon detecting a match, the module(s), such as the gather module 310 (see FIG. 3) within the cybersecurity appliance 105, separates the matched data into a prescribed format consisting of fields (e.g., JSON format). Pre-prompted with a defined specification, example parsing templates, and example pattern and log pairs, the LLM(s) 114 can transform the unstructured data set 111 into a format recognized and utilized by logic within the cyber threat detection engine 130.

While the classification of data pertaining to events (e.g., matched data representing a change to a monitored behavior of a system, environment, process, or workflow) is currently performed manually, the LLM(s) 114 are configured to classify events into buckets (or categories) such as “Admin,” “Login,” and/or “File Creation” for example. Therefore, the LLM(s) 114 can therefore be trained on existing module structures and event classification.

As an illustrative example, a system log-in may be accomplished over many different entry points. These login events may differ such as an interactive login in which the user enters her or his credentials (e.g., username, username/password combination, etc.), a remote interactive login when a remote desktop protocol (RDP) session is established, a biometric login where physical characteristics (e.g., fingerprint, facial parameters, iris, etc.) are captured for authentication, or the like. In contrast with current data parsing techniques in which the data associated with these login events are manually labeled, the LLM(s) 114 are configured to automatically, without user interaction, extract data associated with data associated with IP addresses, or username data, login data, or the like. This may be accomplished through GROK pattern recognition with the received data including login data.

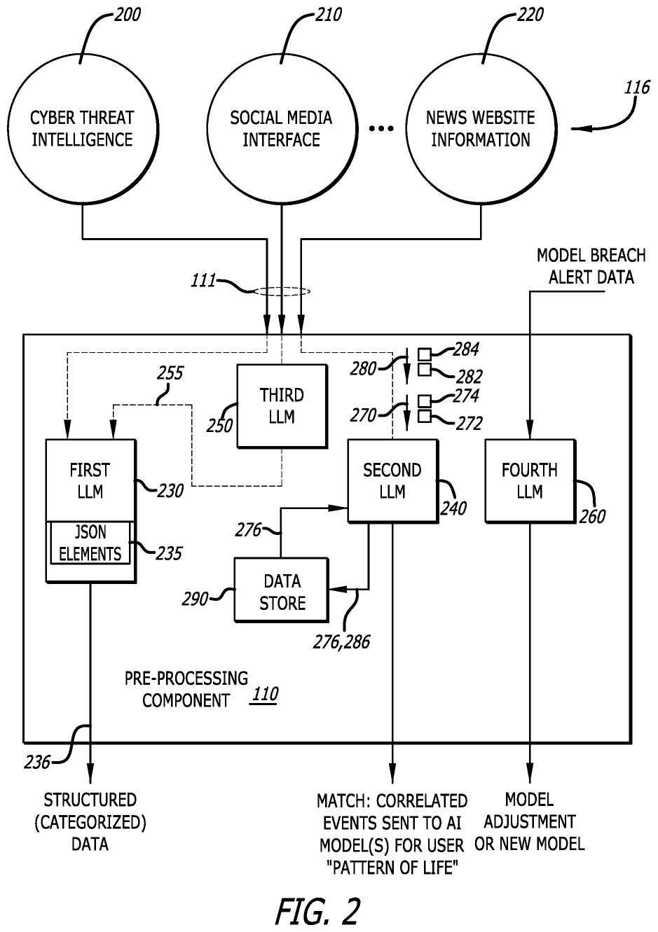

The LLM(s) 114 may be further configured to conduct analytics on contextual data pertaining to similar credentials across different platforms, such as usernames or other presences for example, to determine whether these credentials are associated with the same user. These analytics may involve determining a level of correlation between previously analyzed credentials and credential from the unstructured data set 111 from third-party sources. The unstructured data set 111 is fed into the LLM(s) 114. Using neural language processing, the LLM(s) 114 parse the unstructured data from a large data set including the contextual credential data into structured data, which may be placed into different categories (or buckets) such as labeled as “credential” data. The LLM(s) 114 may be configured to generate a vector associated with the credential data, where the vector may constitute a string of text data associated with the credential data. Examples of the text data string may include, but it is not limited or restricted to permission level of each user (e.g., administrator, etc.), normal time of activity, activities conducted during the normal time of activity, what are the computing devices accessed by the users, or the like. The vector is stored in a data store 290 (see FIG. 2) along with the credentials to create an embedding vector data store.

Thereafter, when the LLM(s) 114 uncover new credential data, the LLM(s) 114 may compare an embedding vector generated for that credential data with embedding vectors maintained in the data store 290. The comparison may involve a fuzzy hash computation and comparison, where a prescribed level of correlation denotes a match. Where a match is detected, the embedding vector (and new credential) is stored to correspond to the matching embedding vector (and credential data). This allows user behaviors associated with potential different patterns of life data to be aggregated, which provides a technological advantage by allowing the AI-based cybersecurity system 100 to supplement existing pattern of life data for that user to better understand normal activities and/or behaviors of that user.

It is contemplated that, in additional to the contextual information associated with the credential data, it is contemplated that other data may be used to assist in the analytics to determine whether an uncovered credential is associated with a different credential previously detected by the LLM(s) 114. The other data may include, but is not limited to MAC IP address, Source IP address, geographic location of the user, or other characteristics associated with the user that may be recovered from the received unstructured data.

The user correlation operations are described for improved cyber threat detection functionality, although the user correlation may be provided to the cyberattack simulation engine 150 and/or the restoration engine 160 to assist in the testing of the cybersecurity environment protected by the AI-based cybersecurity system 100 and/or the restoration/return of a computing device protected by the cybersecurity system to a safe operational state.

As further shown in FIG. 1, the pre-processing component 110 may be configured to conduct PII data anonymization locally on the unstructured data set 111 or the resultant structured data prior to uploading the structured data to a centralized data store or providing to the cyber threat detection engine 130 for training of the AI detection models. This operation improves the accuracy and fidelity of future cyber threat detections by the cyber threat detection engine 130.

Lastly, the pre-processing component 110 include the LLM(s) 114, which are further configured to modify or create new AI detection models, which may be in a JSON format based on at least one model breach alert. A “model breach alert” corresponds to a condition in which a series of logical criteria, represented by the JSON element (data structure) of the AI detection model, have been satisfied to denote that the AI detection model associated with the alert may be “unhealthy,” where tuning or substitution of its operability may be needed. This may be conducted where the AI detection model is experiencing an over-breaching condition, where model breach alerts are being sent too frequently and administrators are failing to respond to these model breach alerts.

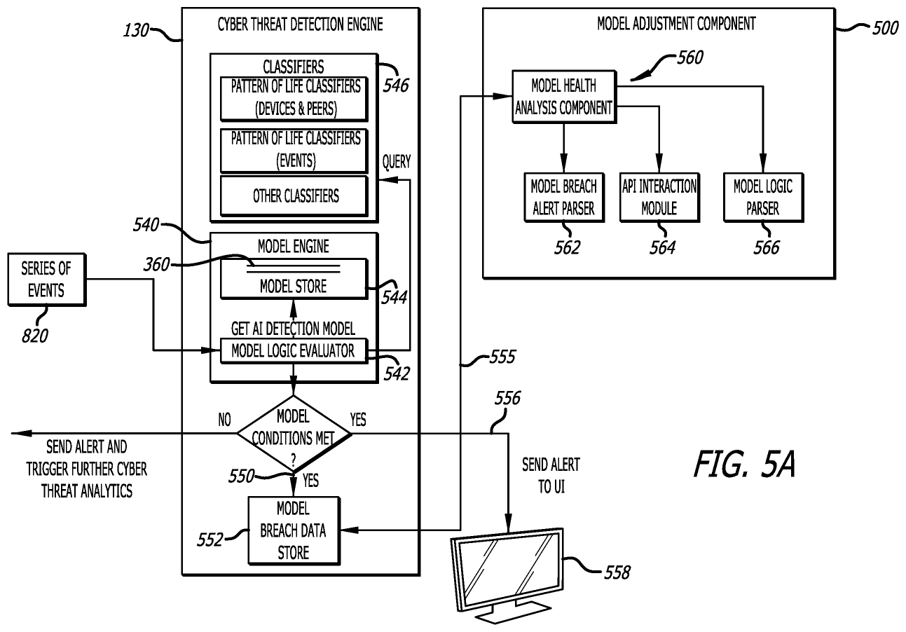

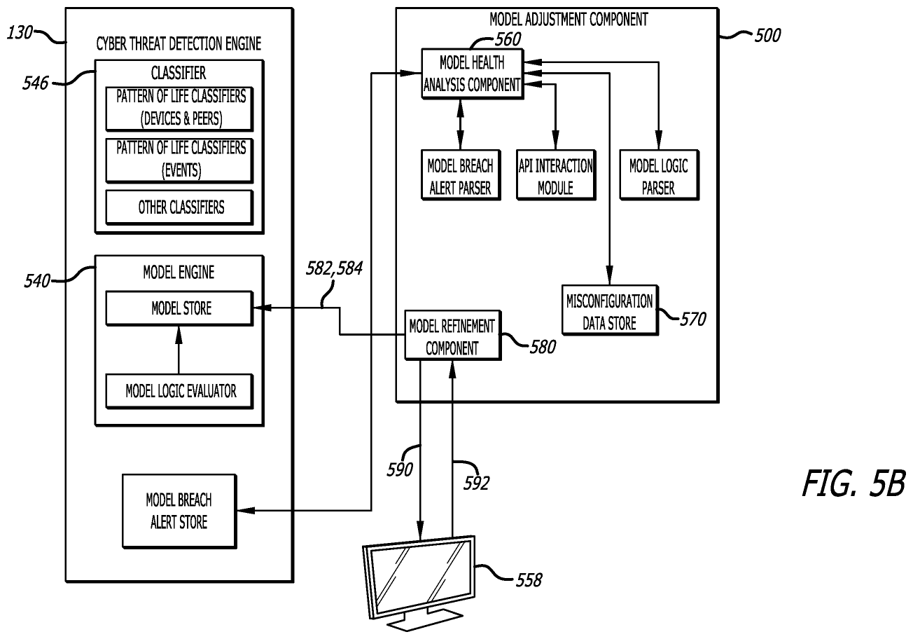

The advent and usage of the LLM(s) 114 have opened up new possibilities in bolstering cybersecurity practices. For example, the cybersecurity system 100 can use an LLM, operating as the model health analyzing component, to provide the breach context data to a model refinement component (see FIG. 5B). Based on the breach context data, the model refinement component is configured to determine one or more suggested adjustments to an existing AI detection model and/or generate new AI detection model without human intervention.

Furthermore, LLM(s) 114 can be trained to generate software code that creates data visualizations, such as graphs and charts, showcasing cybersecurity breaches, user activity, and current cyber threat trends. This capability simplifies the presentation of complex data, enabling stakeholders to grasp key insights quickly.

Referring now to FIG. 2, an illustrative embodiment of the pre-processing component 110, in communication with external sources 116 for receipt of unstructured data set 111 that may be utilized to enhance cyber threat detection functionality by the cybersecurity appliance 105 is shown. Herein, the pre-processing component 110 is configured to receive content associated with the unstructured data set 111 from different sources 116 including, but not limited or restricted to the following: (i) open-source cyber threat intelligence 200, (ii) social media information 210, and/or (iii) news website information 220.

According to this embodiment of the disclosure, as shown in FIGS. 1-2, the pre-processing component 110 includes LLM(s) 114 may be configured as a single LLM or alternatively physically or locally separate LLMs such as multiple LLMs operating separately or in combination (e.g., a nested LLM architecture). As shown for clarity to illustrate distinct operations, the LLM(s) 114 are illustrated by operability as a first LLM 230, a second LLM 240, a third LLM 250, and a fourth LLM 260.

Herein, the first LLM 230 is configured to create one or more JSON elements 235, each operating as a complex filter for extracting salient data from large data sets such as the unstructured data set 111 for further analysis. This filtering provides a generic mechanism to transform the unstructured data set (or restructured data set 255 after PII data removal) into data 236 with a structured format to enable faster integration and usage (in AI detection model training) to improve and/or expand cyber threat detection functionality supported by the cyber threat detection engine 130.

Herein, the first LLM 230 may be configured to utilize one or more AI modules within the AI-based cybersecurity system 100 for pattern matching functionality, such as GROK patterns for example, to parse portions of the received unstructured data set 111 into selected fields. The first LLM 230 is pre-prompted with a defined specification, example parsing templates or example pattern and pairing to cause the first LLM 230 to parse the data into the selected fields as applicable. Hence, the first LLM 230 transform the unstructured data set 111 into a format recognized and utilized by an analyzer module 315 and/or a cyber threat analyst module 320 of FIG. 3 operating as part of the cyber threat detection engine 130.

Continuing the illustrative example described above, the second LLM 240 may be configured to identify and categorize credentials that are utilized in a login operation. The second LLM 240 may be pre-prompted to identify credentials associated with an interactive login (e.g., username & password), a remote interactive login (e.g., a Connection Request message (PDU) and/or username/password during an authentication stage), or the like. In contrast with manually identification of credentials and their labeling, the second LLM 240 is configured to automatically, without user interaction, identify extract data associated with data associated with credentials based on knowledge of the location of the credentials within data exchanges involving interactive logins, remote interactive logins, or the like. This identification may be accomplished through GROK pattern recognition.

Referring still to FIG. 2, the second LLM 240 may be configured to conduct analytics on contextual data pertaining to similar credentials across different platforms, such as usernames or other presences for example, to determine whether these credentials are associated with the same user. In particular, the second LLM 240 is adapted to receive a first unstructured data set 270 that comprises a first contextual data set 272, including a first user credential 274 (e.g., a first user name). Using neural language processing, the second LLM 240 is configured to identify the first user credential 274 within the first unstructured data set 270.

Thereafter, the second LLM 240 may be configured to generate a first embedding vector 276 generated based on the content associated with the first contextual data set 272. For instance, the first embedding vector 276 may constitute a representation (e.g., string of text data, text character pattern) based on content from the first contextual data set 272. According to one embodiment of the disclosure, the representation may constitute a string of text data extracted from the first contextual data set 272 or a text character pattern that is derived from (and perhaps a modification of) content extracted from the first contextual data set 272, such as a one-way hash value or another derivation type. However, the selected representation allows for correlation between two different representations to identify similarities in user credentials and other content. Examples of the content may include, but it is not limited or restricted to the first user credential 274 (user name) and perhaps source public IP address and/or normal hours of activity (e.g., login times identified as morning, afternoon, evening or with more refined granularity such as normal hours of activity, etc.). The first embedding vector 276 may be stored in the data store 290 along with the credentials 274 to create a credential embedding data store.

Subsequently, the second LLM 240 is adapted to receive a second unstructured data set 280 that comprises a second contextual data set 282 including a second user credential 284 (e.g., a second user name). Using neural language processing, the second LLM 240 is configured identify the second user credential 284 and generate a second embedding vector 286 based on the content associated with the second contextual data set 282 as described above.

At that time, the second LLM 240 may access stored embedding vectors within the data store 290 and conduct comparisons between the second embedding vector 286 and some of all of the stored embedding vectors. This comparison may involve a fuzzy hash computation and match is detected when a prescribed level of correlation exists between the second embedding vector 286 and one of the stored embedding vectors (e.g., first embedding vector 276). When a match is detected between the first embedding vector 276 and the second embedding vector 286, the second LLM 240 may associate the second user credential 284 with the first user credential 274 and potentially aggregate (or at least associate) the second contextual data set 282 with the first contextual data set 272, where some of all of this contextual data may be included as part of a “pattern of life” pertaining to the user.

This user correlation scheme provides a technological advantage by allowing the AI-based cybersecurity system 100 to supplement existing pattern of life data for that user to better understand normal activities and/or behaviors of that user.

It is contemplated that the above-identified contextual data set 272 or 282 may be expanded to assist in the analytics by the second LLM 240 to determine whether a credential is associated with a different credential previously detected by the second LLM 240. Examples of the additional data may include, but is not limited to permission level of the user (e.g., administrator, etc.), user actions conducted during the normal time of activity (e.g., assessing certain databases, etc.), what are the computing devices accessed by the users, geographic location of the user, or other characteristics pertain to the user or users associated with the first and second user credentials 274/284.

These user correlation operations are described for improved cyber threat detection functionality, although the user correlation may be provided to the cyberattack simulation engine 150 and/or the cyberattack restoration engine 160 to assist in the testing of the cybersecurity environment protected by the AI-based cybersecurity system 100 and/or the restoration/return of a computing device protected by the cybersecurity system to a safe operational state.

Regarding scalability, the AI detection models tend to be more accurate when they have access to higher volumes of training data, typically resulting in larger models. To accommodate large data storage requirements, the AI detection models may be stored within a centralized data store, such as centralized cloud-based storage. However, such cloud-based storage cannot be applied in many contexts given strict data privacy regulations and/or contractual agreements. Often, anonymization is required before this data may be transported across the Internet.

As further shown in FIG. 2, the third LLM 250 may be configured to conduct PII data anonymization on the unstructured data set 111 or the resultant structured data set prior to uploading the structured data set to the centralized data store and/or providing to the cyber threat detection engine 130 for training of the AI detection models. This operation improves the accuracy and fidelity of future cyber threat detections by the cyber threat detection engine 130. As shown, the third LLM 250 may anonymize the unstructured data set 111 prior to analyses conducted by the first LLM 230. As a result, the structured data 236 may be forwarded over the Internet.

Herein, according to one embodiment of the disclosure, the third LLM 250 is adapted to conduct an anonymization technique that exploits the advantages of NLP to fast and efficiently detect and anonymize PII data in scenarios with limited computational resources. More specifically, the third LLM 250 is configured to initially transform an existing (semi-machine) text into resulting text with a more natural language text form. For instance, text strings within the unstructured data set 111, such as user jane.doe, user jane_doe or user janedoe for example, may be transformed into text strings of the form user Jane Doe. Next, the third LLM 250 processes the resulting text strings in accordance with publicly available natural language models. Thereafter, the third LLM 250 anonymizes the identified relevant PII data from the resulting text strings, which are reconstructed into its original unstructured data set format or structured data set format 255.

The above-described anonymization technique has been evaluated with multiple synthetic and realistic data samples, providing relatively high levels of precision as shown in Table 1 below. The method requires approximately ten milliseconds to process a typical 100-character string running on a modern laptop and requires no less than 50 MB of data in memory.

TABLE 1

| Original Data | Anonymized Data |
|---|---|
| share = \company-fs\profiles | share = \company-fs\profiles |
| path = jdoe\Desktop query = | path = USERNAME\Desktop query = |
| John Doe | PERSON |
| Offline Folder.Ink version = | version = smb2 |
| smb2 | share = \company-fs\profiles |
| share = \company-fs\profiles | path = USERNAME\Desktop query = |
| path = jdoe\Desktop query = | PERSON |
| Joseph Doe | version = smb2 |
| Offline Folder.Ink version = | share = \\Contoso\\Shared |
| smb2 | file = Finance\\PERSON\\Misc\\ |
| share = \\Company\Shared | Contoso\\Credit |
| file = Finance\John | Card Balance.docx version = smb2 |
| Doe\Misc\Company\Credit Card | account = USERNAME |
| Balance.docx version = smb2 | |
| account = johndoe | |

Lastly, the fourth LLM 260 is configured to modify or create new AI detection models, which may be in a JSON format, based information associated with detected model breach alert representing that an AI detection model associated with the model breach alert may be “unhealthy” and tuning or substitution of its operability may be needed. This may be accomplished by the fourth LLM 260, operating as a model health analyzing component without hardcoded solutions, analyzing and aggregating breach context data, namely (i) the model breach alert information and their triggers, (ii) information about the events and/or computing device(s) involved in these model breach alerts, (iii) potential reasons for the model breach alerts, and/or (iv) data pertain to the AI detection model that identified the model breach alerts. This breach context data aids in detecting ineffective AI detection models, due to operation or over breaching where tuning of the cyber threat detection thresholds may be warranted.

Referring to FIG. 3, an illustrative block diagram of an embodiment of the AI-based cybersecurity appliance with components forming the cyber threat detection engine 130 of FIG. 1 that protects an enterprise from cyber threats is shown. Various Artificial Intelligence models and modules of the cybersecurity appliance 105 cooperate to protect a system, such as one or more networks/domains under analysis, from cyber threats. As shown, according to one embodiment of the disclosure, the AI-based cybersecurity appliance 105 may include a trigger module 305; a gather module 310; a cyber threat detection engine 130 including an analyzer module 315, a cyber threat analyst module 320, an assessment module 325, a first (1^{st}) domain module 330, a second (2^{nd}) domain module 335, and a coordinator module 340; a user interface and formatting module 345, a data store 350, the cyber threat autonomous response engine 140, one or more AI models and/or other model types (hereinafter, “model(s) 360”), an interface 370 to the cyberattack restoration engine 160, an interface 375 to the cyberattack simulation engine 150, and other similar components.

Herein, a first AI model 361 of the model(s) 360 may be trained with machine learning on a normal pattern of life for entities (e.g., users, etc.) in the network(s)/domain(s) under analysis, with machine learning on cyber threat hypotheses to form and investigate a cyber threat hypothesis on what are a possible set of cyber threats and their characteristics, symptoms, remediations, etc. Other model(s) 360, such as a second AI model 362 for example, may be trained on possible cyber threats including their characteristics and symptoms.

The cybersecurity appliance 105 can host the cyber threat detection engine and other components. The cybersecurity appliance 105 includes a set of modules cooperating with one or more AI models configured to perform a machine-learned task of detecting a cyber threat incident, sometime referred to as “AI detection models.” The cyber threat detection engine 130 uses the AI detection modules of the model(s) 360 to detect anomalous behavior of one or more nodes, including at least user accounts, devices, and versions of source code files, in a graph of a system being protected. The cyber threat detection engine 130 further uses the set of modules cooperating with the model(s) 360 in the cybersecurity appliance 105 to prevent a cyber threat from compromising the nodes and/or spreading through the nodes of the AI-based cybersecurity system 100 of FIG. 1.

The cybersecurity appliance 105 may be configured to a network/domain from a cyber threat (e.g., insider attack, malicious files, malicious emails, etc.). In an embodiment, the cybersecurity appliance 105 can protect all of the devices on the network(s)/domain(s) being monitored by monitoring domain activity including communications). For example, an IT network domain module (e.g., first domain module 330) may communicate with network sensors to monitor network traffic going to and from the computing devices on the network as well as receive secure communications from software agents embedded in host computing devices/containers. The steps below will detail the activities and functions of several of the components in the cybersecurity appliance 105. Also, a pre-processing interface 300 provides the LLM(s) 114, when deployed within the pre-processing component 110, with access to engines/modules within the cybersecurity appliance 105 and/or engines/modules accessible by the cybersecurity appliance 105. I/O ports 365 provide I/O access for data processing by the cybersecurity appliance 105.

The gather module 310 may be configured with one or more process identifier classifiers. Each process identifier classifier may be configured to identify and track one or more processes and/or devices in the network, under analysis, making communication connections. The data store 350 cooperates with the process identifier classifier to collect and maintain historical data of processes and their connections, which is updated over time as the network is in operation. Individual processes may be present in merely one or more domains being monitored. In an example, the process identifier classifier can identify each process running on a given device along with its endpoint connections, which are stored in the data store 350. In addition, a feature classifier can examine and determine features in the data being analyzed into different categories.

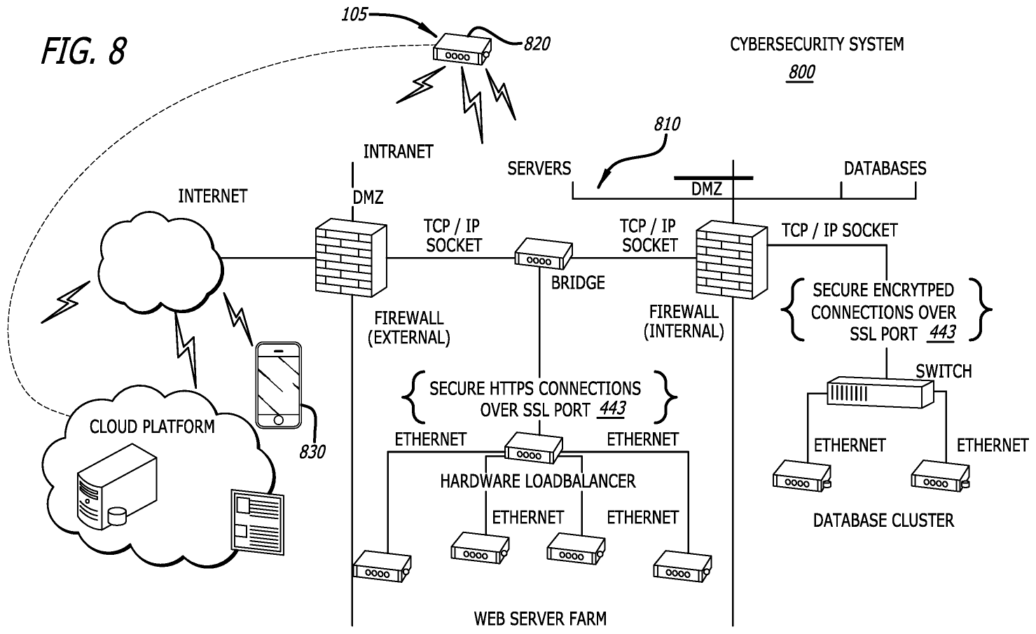

The analyzer module 315 can cooperate with the model(s) in the cybersecurity appliance 105 to confirm a presence of a cyberattack against one or more domains in an enterprise (e.g., see enterprise 800 of FIG. 8). A process identifier in the analyzer module 315 can cooperate with the gather module 310 to collect any additional data and metrics to support a possible cyber threat hypothesis. Similarly, the cyber threat analyst module 320 can cooperate with the internal data sources as well as external data sources to collect data in its investigation. More specifically, the cyber threat analyst module 320 can cooperate with the model(s) 360 in the cybersecurity appliance 105 to conduct a long-term investigation and/or a more in-depth investigation of potential and emerging cyber threats directed to one or more domains in an enterprise's system.

Herein, the cyber threat analyst module 320 and/or the analyzer module 315 can also monitor for other anomalies, such as model breaches, including, for example, deviations for a normal behavior of an entity, and other techniques discussed herein. As an illustrative example, the analyzer module 315 and/or the cyber threat analyst module 320 can cooperate with the second AI model 362 trained on potential cyber threats in order to assist in examining and factoring these additional data points that have occurred over a given timeframe to see if a correlation exists between 1) a series of two or more anomalies occurring within that time frame and 2) possible known and unknown cyber threats. The cyber threat analyst module 320 can cooperate with the internal data sources as well as external data sources, including structured data provided to the data store 350 by the pre-processing component 110 of FIGS. 1-2, to collect data in its investigation.

According to one embodiment of the disclosure, the cyber threat analyst module 320 allows two levels of investigations of a cyber threat that may suggest a potential impending cyberattack. In a first level of investigation, the analyzer module 315 and model(s) 360 can rapidly detect a potential cyber threat and then the cyber threat autonomous response engine 140 will autonomously respond to overt and obvious cyberattacks. However, thousands to millions of low level anomalies occur in a domain under analysis all of the time; and thus, most other systems need to set the threshold of trying to detect a cyberattack by a cyber threat at level higher than the low level anomalies examined by the cyber threat analyst module 320 just to not have too many false positive indications of a cyberattack when one is not actually occurring, as well as to not overwhelm a human cybersecurity analyst receiving the alerts with so many notifications of low level anomalies that they just start tuning out those alerts. However, advanced persistent threats attempt to avoid detection by making these low-level anomalies in the system over time during their cyberattack before making their final coup de grâce/ultimate mortal blow against the system (e.g., domain) being protected. The cyber threat analyst module 320 also conducts a second level of investigation over time with the assistance of the model(s) 360 trained with machine learning on how to form cyber threat hypotheses and how to conduct investigations for a cyber threat hypothesis that can detect these advanced persistent cyber threats actively trying to avoid detection by looking at one or more of these low-level anomalies as a part of a chain of linked information.

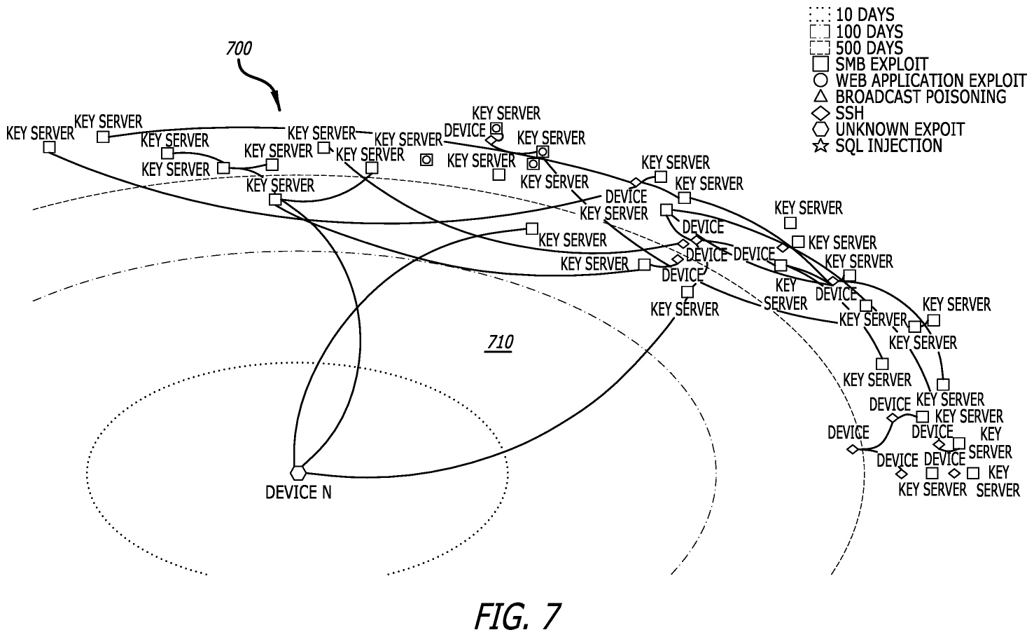

Note, a data analysis process can be algorithms/scripts written by humans to perform their function discussed herein; and can in various cases use AI classifiers as part of their operation. The cyber threat analyst module 320 forms in conjunction with the model(s) 360 trained with machine learning on how to form cyber threat hypotheses and how to conduct investigations for a cyber threat hypothesis investigate hypotheses on what are a possible set of cyber threats. The cyber threat analyst module 320 can also cooperate with the analyzer module 315 with its one or more data analysis processes to conduct an investigation on a possible set of cyber threats hypotheses that would include an anomaly of at least one of i) the abnormal behavior, ii) the suspicious activity, and iii) any combination of both, identified through cooperation with, for example, the model(s) 360 trained with machine learning on the normal pattern of life of entities in the system. For example, as shown in FIG. 7, the cyber threat analyst module 320 may perform several additional rounds 710 of gathering additional information, including abnormal behavior, over a period of time, in this example, examining data over an 8-day period to determine causal links between the information. The cyber threat analyst module 320 may submit to check and recheck various combinations/a chain of potentially related information, including abnormal behavior of a device/user account under analysis for example, until each of the one or more hypotheses on potential cyber threats are one of 1) refuted, 2) supported, or 3) included in a report that includes details of activities assessed to be relevant activities to the anomaly of interest to the user and that also conveys at least this particular hypothesis was neither supported or refuted. For this embodiment, a human cybersecurity analyst is needed to further investigate the anomaly (and/or anomalies) of interest included in the chain of potentially related information.

Returning still to FIG. 3, an input from the cyber threat analyst module 320 of a supported hypothesis of a potential cyber threat will trigger the analyzer module 315 to compare, confirm, and send a signal to act upon and mitigate that cyber threat. In contrast, the cyber threat analyst module 320 investigates subtle indicators and/or initially seemingly isolated unusual or suspicious activity such as a worker is logging in after their normal working hours or a simple system misconfiguration has occurred. Most of the investigations conducted by the cyber threat analyst module 320 cooperating with the model(s) 360 trained with machine learning on how to form cyber threat hypotheses and how to conduct investigations for a cyber threat hypothesis on unusual or suspicious activities/behavior may not result in a cyber threat hypothesis that is supported but rather most are refuted or simply not supported.

Typically, during the investigations, several rounds of data gathering to support or refute the long list of potential cyber threat hypotheses formed by the cyber threat analyst module 320 will occur before the algorithms in the cyber threat analyst module 320 will determine whether a particular cyber threat hypothesis is supported, refuted, or needs further investigation by a human. The rounds of data gathering may build chains of linked low-level indicators of unusual activity along with potential activities that could be within a normal pattern of life for that entity to evaluate the whole chain of activities to support or refute each potential cyber threat hypothesis formed. For example, a chain of linked low-level indicators, including abnormal behavior compared to the normal patten of life for that entity, all under a prescribed score that indicates an anomalous activity. The investigations by the cyber threat analyst module 320 can happen over a relatively long period of time and be far more in depth than the analyzer module 315 which will work with the other modules and model(s) 360 to confirm that a cyber threat has in fact been detected.

The gather module 310 may further extract data from the data store 350 at the request of the cyber threat analyst module 320 and/or analyzer module 315 on each possible hypothetical threat that would include the abnormal behavior or suspicious activity and then can assist to filter that collection of data down to relevant points of data to either 1) support or 2) refute each particular hypothesis of what the cyber threat, the suspicious activity and/or abnormal behavior relates to. The gather module 310 cooperates with the cyber threat analyst module 320 and/or analyzer module 315 to collect data to support or to refute each of the one or more possible cyber threat hypotheses that could include this abnormal behavior or suspicious activity by cooperating with one or more of the cyber threat hypotheses mechanisms to form and investigate hypotheses on what are a possible set of cyber threats.

Thus, the cyber threat analyst module 320 is configured to cooperate with the model(s) 360 trained with machine learning on how to form cyber threat hypotheses and how to conduct investigations for a cyber threat hypothesis to form and investigate hypotheses on what are a possible set of cyber threats and then can cooperate with the analyzer module 315 with the one or more data analysis processes to confirm the results of the investigation on the possible set of cyber threats hypotheses that would include the at least one of i) the abnormal behavior, ii) the suspicious activity, and iii) any combination of both, identified through cooperation with the model(s) 360 trained with machine learning on the normal pattern of life/normal behavior of entities in the domains under analysis.

Note, in the first level of threat detection, the gather module 310 and the analyzer module 315 cooperate to supply any data and/or metrics requested by the analyzer module 315 cooperating with the model(s) 360 trained on possible cyber threats to support or rebut each possible type of cyber threat. Again, the analyzer module 315 can cooperate with the model(s) 360 and/or other modules to rapidly detect and then cooperate with the (cyber threat) autonomous response engine 140 to autonomously respond to overt and obvious cyberattacks, (including ones found to be supported by the cyber threat analyst module 320).

As a starting point, the cybersecurity appliance 105 can use multiple modules, each capable of identifying abnormal behavior and/or suspicious activity against the model(s) 360 trained on a normal pattern of life for the entities in the network/domain under analysis, which is supplied to the analyzer module 315 and/or the cyber threat analyst module 320. The analyzer module 315 and/or the cyber threat analyst module 320 may also receive other inputs such as AI model breaches, AI classifier breaches, etc. a trigger to start an investigation from an external source.

Many other model breaches of the model(s) 360 trained with machine learning on the normal behavior of the system can send an input into the cyber threat analyst module 320 and/or the trigger module to trigger an investigation to start the formation of one or more hypotheses on what are a possible set of cyber threats that could include the initially identified abnormal behavior and/or suspicious activity. Note, a deeper analysis can look at example factors such as i) how long has the endpoint existed or is registered; ii) what kind of certificate is the communication using; iii) is the endpoint on a known good domain or known bad domain or an unknown domain, and if unknown what other information exists such as registrant's name and/or country; iv) how rare; v), etc.

Note, the cyber threat analyst module 320 cooperating with the model(s) 360 trained with machine learning on how to form cyber threat hypotheses and how to conduct investigations for a cyber threat hypothesis in the cybersecurity appliance 105 provides an advantage as it reduces the time taken for human led or cybersecurity investigations, provides an alternative to manpower for small organizations and improves detection (and remediation) capabilities within the cybersecurity appliance 105.

The cyber threat analyst module 320, which forms and investigates hypotheses on what are the possible set of cyber threats, can use hypotheses mechanisms including any of 1) one or more of the model(s) 363 trained on how human cybersecurity analysts form cyber threat hypotheses and how to conduct investigations for a cyber threat hypothesis that would include at least an anomaly of interest, 2) one or more scripts outlining how to conduct an investigation on a possible set of cyber threats hypotheses that would include at least the anomaly of interest, 3) one or more rules-based models 364 on how to conduct an investigation on a possible set of cyber threats hypotheses and how to form a possible set of cyber threats hypotheses that would include at least the anomaly of interest, and 4) any combination of these. Again, the model(s) 360 trained on ‘how to form cyber threat hypotheses and how to conduct investigations for a cyber threat hypothesis’ may use supervised machine learning on human-led cyber threat investigations and then steps, data, metrics, and metadata on how to support or to refute a plurality of the possible cyber threat hypotheses, and then the scripts and rules-based models will include the steps, data, metrics, and metadata on how to support or to refute the plurality of the possible cyber threat hypotheses. The cyber threat analyst module 320 and/or the analyzer module 315 can feed the cyber threat details to the assessment module 325 to generate a threat risk score that indicate a level of severity of the cyber threat.

Each of the multiple AI-based engines 130, 140, 150 & 160 has an interface to communicate with each other and to communicate with another separate AI-based engine, which is configured to understand a type of information and communication that this other separate AI-based engine needs to make determinations on an ongoing cyberattack from that other AI-based engine's perspective. The autonomous response engine 140 works with the assessment module in the detection engine when the cyber threat is detected and autonomously takes one or more actions to mitigate the cyber threat.

The cyber threat detection engine 130 may also be configured with the user interface and formatting module 345, which may include an anomaly alert system configured to report out anomalous incidents and events as well as the cyber threat detected to a display screen viewable by a human cybersecurity professional. Each AI-based engine 130, 140, 150 & 160 of FIG. 1 has a rapid messaging system to communicate with a human cybersecurity team to keep the human cybersecurity team informed on actions autonomously taken and actions needing human approval to be taken.

Referring still to FIGS. 1 & 3, the cyberattack restoration engine 160 is configured to take one or more remediation actions based on configured and/or Artificial Intelligence assistance to remediate the one or more nodes in the graph of the system being protected back to a trusted operational state in a recovery from the cyber threat. These actions might be fully automatic or require a specific human confirmation decision before they begin. The cyberattack restoration engine 160 is configured to cooperate with the other AI-based engines 130, 140, and 150 of the AI-based cybersecurity system 100, via the interfaces and/or direct integrations, to track and understand the cyber threat identified by the other components as well as track the one or more mitigation actions taken to mitigate the cyber threat during the cyberattack by the other components in order to assist in intelligently restoring the protected system while still mitigating the cyber threat attack back to a trusted operational state; and thus, as a situation develops with an ongoing cyberattack, the cyberattack restoration engine 160 is configured to take one or more remediation actions to remediate (e.g. restore) at least one of the nodes in the graph of the protected system back to a trusted operational state while the cyberattack is still ongoing.

According to one embodiment, as shown in FIGS. 1-2, the intelligent pre-processing component 110 can be configured as a discreet component that logically exists on top of the multiple AI-based engines 130, 140, 150 & 160 to orchestrate the overall cyber threat response and an interaction between the multiple AI-based engines, each configured to perform its own machine-learned task. Alternatively, the pre-processing component 110 can be configured as a distributed collaboration with a portion of the intelligent pre-processing component 110, including the LLM(s) 114, implemented in each of the multiple AI-based engines 130, 140, 150 & 160 to orchestrate the overall cyber threat response and an interaction between the multiple AI-based engines 130, 140, 150 & 160. Independent of its deployment, the pre-processing component 110 can use self-learning algorithms to (i) pre-process data to improve the quality of cyber threat detections performed by or expand the ability of such detections and/or (ii) adjust functionality of logic associated with the cyber threat detection engine 130 or create new cyber threat detection logic such as new AI detection models for example.

The multiple AI-based engines can be configured to cooperate to combine an understanding of normal operations of the nodes, an understanding emerging cyber threats, an ability to contain those emerging cyber threats, and a restoration of the nodes of the system to heal the system with an adaptive feedback between the multiple AI-based engines in light of simulations of the cyberattack to predict what might occur in the nodes in the system based on the progression of the attack so far, mitigation actions taken to contain those emerging cyber threats and remediation actions taken to heal the nodes using the simulated cyberattack information.

One or more AI models in the detection engine can be configured to maintain what is considered to be normal behavior for that node, which is constructed on a per node basis, on the system being protected from historical data of that specific node over an operation of the system being protected.

The multiple AI-based engines each have an interface to communicate with the other separate AI-based engines configured to understand a type of information and communication that the other separate AI-based engine needs to make determinations on an ongoing cyberattack from that other AI-based engine's perspective. Each AI-based engine has an instant messaging system to communicate with a human cybersecurity team to keep the human cybersecurity team informed on actions autonomously taken and actions needing human approval as well as generate reports for the human cybersecurity team.

Referring to FIGS. 1-3, the cyber threat detection engine 130 is configured with AI logic trained to perform a first machine-learned task of detecting the cyber threat. The cyber threat autonomous response engine 140 is configured with AI logic trained to perform a second machine-learned task of taking one or more actions to mitigate a detected cyber threat. Furthermore, the cyberattack restoration engine 160 is configured, using AI logic using trained to perform a third machine-learned task of remediating operability of the cybersecurity appliance 105 being protected back to a trusted operational state. Lastly, the cyberattack simulation engine 150 using Artificial Intelligence algorithms trained to perform a fourth machine-learned task of AI-based simulations of cyberattacks to assist in determining 1) how a simulated cyberattack might occur in the system being protected, and 2) how to use the simulated cyberattack information to preempt possible escalations of an ongoing actual cyberattack, in order for these four AI-based engines to work together. In addition, the intelligent pre-processing component can use Artificial Intelligence algorithms trained to perform a fifth machine-learned task of adaptive interactive response between the multiple AI-based engines to provide information each Artificial Intelligence engine needs to work cohesively to provide an overall incidence response that mitigates different types of cyber threats while still minimizing an impact tailored to this particular system being protected. For example, when a conversation occurs between the AI-based engines such as a system that can be positively affected by both proposed mitigation actions and proposed restoration actions, any of which might be attempted but fail or only partially succeed, then the intelligent pre-processing component can arbitrate and evolve the best result for this particular system being protected. The intelligent pre-processing component can help anticipate i) the needs of and ii) cohesive response of each AI-based engine based on a current detected cyber threat.

The cyberattack restoration engine 160 receives and sends inputs through communication hooks (e.g., interfaces) to all of these AI-based engines each configured with self-learning AI machine learning algorithms to, respectively, i) to detect the cyber threat, ii) to respond to mitigate that cyber threat, and iii) to predict how that cyber threat might occur and likely progress through simulations. Each of these AI-based engines has bi-directional communications, including the exchange of raw data, with each other as well as with software agents resident in physical and/or virtual devices making up the system being protected as well as bi-directional communications with sensors within the system being protected. Note, the system under protection can be, for example, an IT network, an OT network, a Cloud network, an email network, a source code database, an endpoint device, etc.

In an example, the (cyber threat) autonomous response engine 140 uses its intelligence to cooperate with a cyberattack simulation engine and its AI-based simulations to choose and initiate an initial set of one or more mitigation actions indicated as a preferred targeted initial response to the detected cyber threat by autonomously initiating those mitigation actions to defend against the detected cyber threat, rather than a human taking an action. The autonomous response engine 140, rather than the human taking the action, is configured to autonomously cause the one or more mitigation actions to be taken to contain the cyber threat when a threat risk parameter from an assessment module in the detection engine is equal to or above an actionable threshold. Example mitigation actions can include 1) the autonomous response engine 140 monitoring and sending signals to a potentially compromised node to restrict communications of the potentially compromised node to merely normal recipients and types of communications according to the Artificial Intelligence model trained to model the normal pattern of life for each node in the protected system, 2) the autonomous response engine 140 trained on how to isolate a compromised node as well as to take mitigation acts with other nodes that have a direct nexus to the compromised node.

In another example, the cyberattack simulation engine 150 and its AI-based simulations use intelligence to cooperate with the cyberattack restoration engine 160 to assist in choosing one or more remediation actions to perform on nodes affected by the cyberattack back to a trusted operational state while still mitigating the cyber threat during an ongoing cyberattack based on effects determined through the simulation of possible remediation actions to perform and their effects on the nodes making up the system being protected and preempt possible escalations of the cyberattack while restoring one or more nodes back to a trusted operational state.

In another example, the cyberattack restoration engine 160 restores the one or more nodes in the protected system by cooperating with at least two or more of 1) an AI model trained to model a normal pattern of life for each node in the protected system, 2) an AI model trained on what are a possible set of cyber threats and their characteristics and symptoms to identify the cyber threat (e.g. malicious actor/device/file) that is causing a particular node to behave abnormally (e.g. malicious behavior) and fall outside of that node's normal pattern of life, and 3) the autonomous response engine 140.

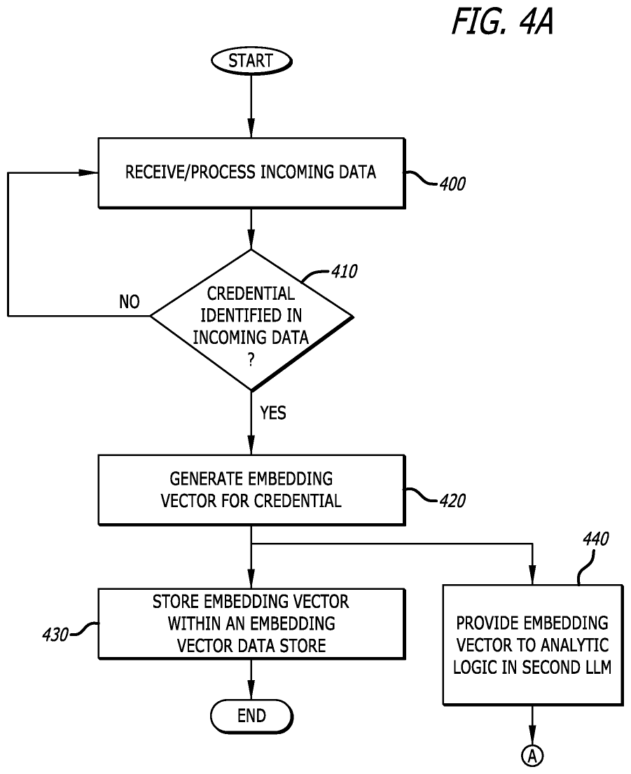

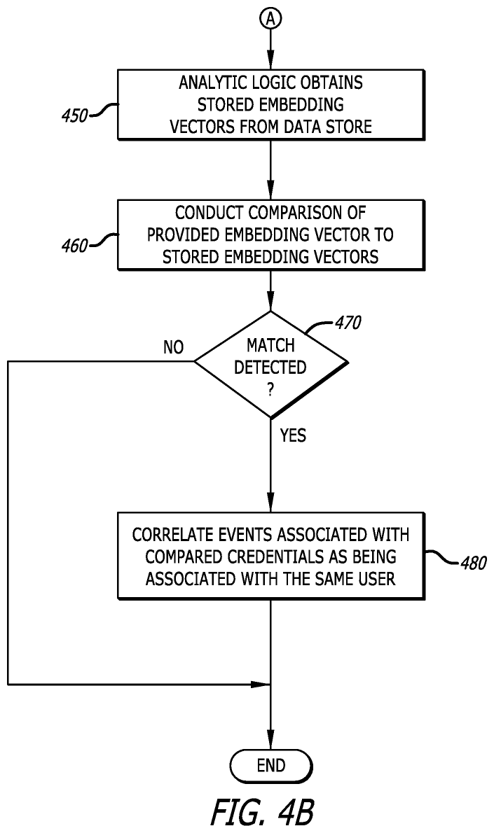

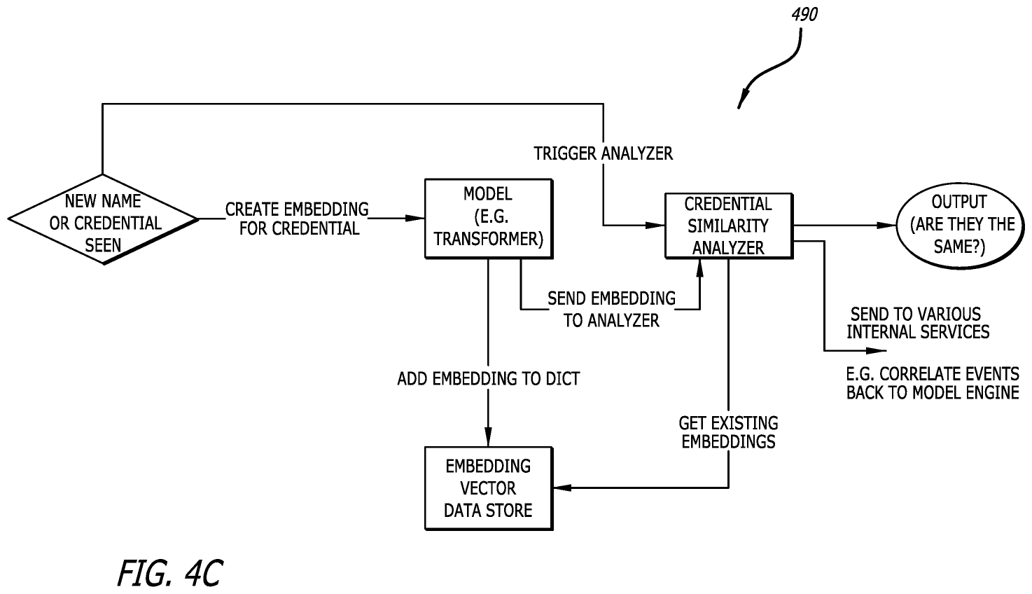

Referring now to FIGS. 4A-4B, illustrative flowcharts of the operations performed by the LLM(s) 114 of FIG. 1, namely the second LLM 240 of FIG. 2, to store and correlate credentials for users of the enterprise to enhance cyber threat detection is shown. Besides JSON element and complex filtering creation and PII data anonymization as described above, credential correlation is another technique to assist in cyber threat detection. As described above, the second LLM 240 is configured to process incoming data (e.g., anonymized, unstructured data set 111 from third party source(s), model breach alert, etc.) and some or all of the LLM(s) 114 may be deployed within the pre-processing component 110 illustrated in FIG. 1, an AI-based engine such as a cyber threat detection engine 130 of the cybersecurity appliance 105 illustrated in FIG. 1, and/or a module within an AI-based engine such as the cyber threat detection engine 130.

As shown in FIG. 4A, the second LLM 240 is configured to generate and store embedding vectors based on detected credentials in efforts to correlate users of different platforms so that patterns of life (aggregate of user behavior) is augmented with additional user behavior/characteristics to increase cyber threat detection associated with that user (i.e., better understand normal activities and/or behaviors of a user increases the ability to detect a cyber threat associated with that user). Herein, the second LLM 240 receives the incoming data (operation 400). Upon detection of a credential within the incoming data, such as a user credential for example, an AI model utilized by the second LLM 240 generates an embedding vector (operations 410 and 420). According to one embodiment of the disclosure, the embedding vector may correspond to a sequence of text data associated with the credential such as at least the user name or user path. Additionally, the sequence of text data may include, but it is not limited or restricted to permission level of the user (e.g., administrator, etc.), time of activity, activities conducted during the normal time of activity, addressing information to identify the computing devices being utilized the users and/or the geographical location of the user, or the like. According to one embodiment of the disclosure, the sequence of text data may further undergo an encoding process (e.g., one-way hash operation, etc.) in which the encoding with a portion of identical contents may result in certain portions of the embedding vector matching a similarly situated portion of another embedding vector.

Thereafter, the embedding vector may be stored within a data store (operation 430). According to one embodiment, the embedding vector data store may be configured as a relational database in which embedding vectors associated with the same user may be linked or as a non-relational database to merely retain the embedding vectors in a searchable form. Additionally, the embedding vector may be also provided to analytics logic within the second LLM 240 to determine whether the detected credential is associated with a user utilizing the same or similar credential in a different platform (operation 440).

Referring now to FIG. 4B, the second LLM 240 is further configured to conduct analytics on the generated embedding vector to determine a likelihood of compared credentials utilized in different platforms being associated with the same user. Herein, operations 400-440 are performed as described above. In response to a triggering event, the analytics logic (credential similarity analyzer) obtains stored embedding vectors and conducts a comparison analysis between the detected embedding vector and previously stored embedding vectors maintained within the embedding vector data store (operations 450, 460 & 470).

According to one embodiment of the disclosure, the triggering event may be conducted periodically (e.g., during a prescribed time period such as during daily system backup or system maintenance outside of business hours of the enterprise, etc.) or aperiodically in response to a manual request by an enterprise administrator. According to another embodiment of the disclosure, the comparison analysis may involve a fuzzy hash computation and comparison, where a prescribed level of correlation between a detected embedding vector and a stored embedding vector denotes a match. Where a “match” is detected, the embedding vector (and new credential data) is stored to correspond to the matched (prior stored) embedding vector (and credential data). This allows user-based events (e.g., behaviors, etc.) associated with potential different patterns of life data to be aggregated, which provides a technological advantage by allowing the AI-based cyber threat detection engine to supplement event data associated with multiple user credential to a common pattern of life model for that user to better understand normal activities and/or behaviors of that user and improve cyber threat detection associated with that user (operation 480). This may include pattern of life model updates, notify services to correlate future events from these credentials to the same user, etc.

As further shown in FIG. 4C, a workflow 490 of analytics conducted by one or more LLMs, such as the second LLM 240, for credential comparison is shown. Referring now to FIGS. 5A-5B, illustrative block diagrams of an

embodiment of a model adjustment component 500 deployed within the cybersecurity system 100 of FIG. 1 (e.g., within cyber threat detection engine 130, within the cybersecurity appliance 105, or separate therefrom), which is configured to create or adjust specific model(s) 360 (e.g., AI detection model 510 formed by or possibly utilizing LLMs) to improve cyber threat detection, is shown. Herein, the creation or adjustment of AI detection models is conducted in response to detection of a model breach alert and subsequent analysis on the health of the AI detection model(s) associated with the model breach alert.

As described herein, a “model breach alert” generally refers to an action triggered in response to the AI detection model 510 (i.e., one or more pre-prompted, trained AI models associated with cyber threat detection) detecting that at least one event from a series of events 520, received and evaluated by the AI detection model 510, represents anomalous behavior or a specific pattern of activity that may indicate a potential cyber threat. The AI detection model 510 defines a set of conditions that could be arranged as a JSON data structure, where the set of conditions may be directed to “pattern of life” anomaly detection, suspicious behavior represented by the one or more events (e.g., detected suspicious lateral movement of data within the enterprise), or model compliance issues. When the set of conditions are satisfied, the cyber threat detection engine 130 (e.g., AI detection model 510) generates the model breach alert 530.

More specifically, according to one embodiment of the discussion, a model engine 540, which is representative of logic associated with the analyzer module 315 of the cybersecurity appliance 105 (hereinafter, “model logic evaluator 542”) and a data store 544 that maintains the model(s) 360, receives the series of events 520. The model logic evaluator 542 may be configured to query classifiers 546 of the cybersecurity appliance 105 to obtain information associated with one or more devices or one or more events relevant to each AI model for use in determining whether the set of conditions associated with the AI model have been met pertaining to what device(s) or event(s) are relevant to analytics conducted by each model.

Thereafter, the model logic evaluator 542, utilizing at least the AI detection model 510, determines whether the set of conditions associated with the AI detection model 510 has been satisfied. If so, the model engine 540 generates a model breach alert 550 in response to the series of events 520, where content associated with the model breach alert 550 is stored in a model breach data store 552 and optionally provided as content 556 associated with the model breach alert 550 to a user interface 558 associated with the cybersecurity appliance (e.g., graphics user interface where an identifier of the model breach alert 550 and selected contents of the model breach alert (e.g., time, severity, targeted destination, type of potential cyber threat) is shown.

Thereafter, as shown in FIG. 5A, the model adjustment component 500 is configured to ingest content 555 associated with detected model breach alerts from the model breach data store 552. The content 555 may be ingested in real-time in response to detection and storage, or may be ingested periodically (e.g., prescribed periods of time to update the model(s) 360, or aperiodically based on an administrative request message. From the ingested content 555, the model adjustment component 500 may be configured to assess a health of the AI detection model 510 responsible for the model breach alert 550.

Herein, according to one embodiment of the disclosure, the model adjustment component 500 features a model health analysis component 560 formed by plurality of analytic logic (analyzers), which are constantly ingesting data about model breach activities for subsequent evaluation of the health of the AI model(s) 360. Herein, these analyzers may include, but are not limited or restricted to (i) an alert model breach parser 562, (ii) an API interaction module 564, and/or (iii) a model logic parser 566. The alert model breach parser 562 is adapted to extract information to understand how/why the set of conditions associated with the AI detection model 510 was satisfied. This may include triggering event(s) as to the detected model breach. In contrast, the API interaction module 564 is adapted as API logic or an LLM to query logic within the cybersecurity appliance 105 or even the cybersecurity system for more information associated with the model breach alert 550. The model logic parser 566 is adapted to conduct analytics to understand the intended operability of the AI detection model 510, not the reasons for the detection through comparison such as comparison of different JSON elements as conducted by the alert model breach parser 562.

In summary, the model health analysis component 560 is configured to retrieve content to evaluate the health of the model(s) 360 by at least understanding why a model breach alert was generated and the intended purpose of the AI detection model 510 to assess whether the generated model breach alert is aligned with the intended purpose.

As further shown in FIG. 5B, the model adjustment component 500 further comprises a misconfiguration data store (hardcoded) 570 and a model refinement component 580. The misconfiguration data store 570 is hardcoded to include contextual information associated with potential AI model misconfigurations that may be utilized if the model health analysis component 560 determines that any of the evaluated AI model(s) 360 appears to be misconfigured based on the activities that caused the model breach to occur.

More specifically, based on content retrieved and analyzed by the alert model breach parser 562, the API interaction module 564 and the model logic parser 566, along with the content provided from the misconfiguration data store 570, the model refinement component 580 determines adjustments 582 to the AI detection model or a new AI detection model 584 (in substitution of the AI detection model 510) to avoid an over-breaching condition and/or improve cyber threat detection and compliance by the user. Stated differently, the model refinement component 580 is configured to determine the adjustments 582 to the AI model, which may include at least one or more exceptions to increase a model breath threshold associated with one or more types of model breach alerts to address an over-breaching condition that corresponds to a condition where a number or frequency of detections of a type of model breach alert is greater than a prescribed number or frequency to cause an administrator to ignore a notification of this type of model breach alert.

For example, the adjustments 582 to the AI detection model 510 may include altering the AI detection model 510 with one or more exceptions to increase the model breath threshold so that the severity needed to detect a model breach increases so that, upon receipt of this type of model breach alert, actions to mitigate and address the model breach alert may timely occur as the urgency/severity of the model breach has increased.

According to one embodiment of the disclosure, the model refinement component 580 may be configured to initiate a message 590 to an administrator identifying at least the adjustments recommended by the model refinement component and awaiting an acknowledgement message 592 from the administrator. The acknowledgement message 592 signifies that the model refinement component 580 is authorized to proceed with the adjustments to the AI detection model 510 (or substitution of the AI detection model 510). Alternatively, the model refinement component 580 may be configured to automatically, without user intervention, adjustment or replace to the AI detection model 510.

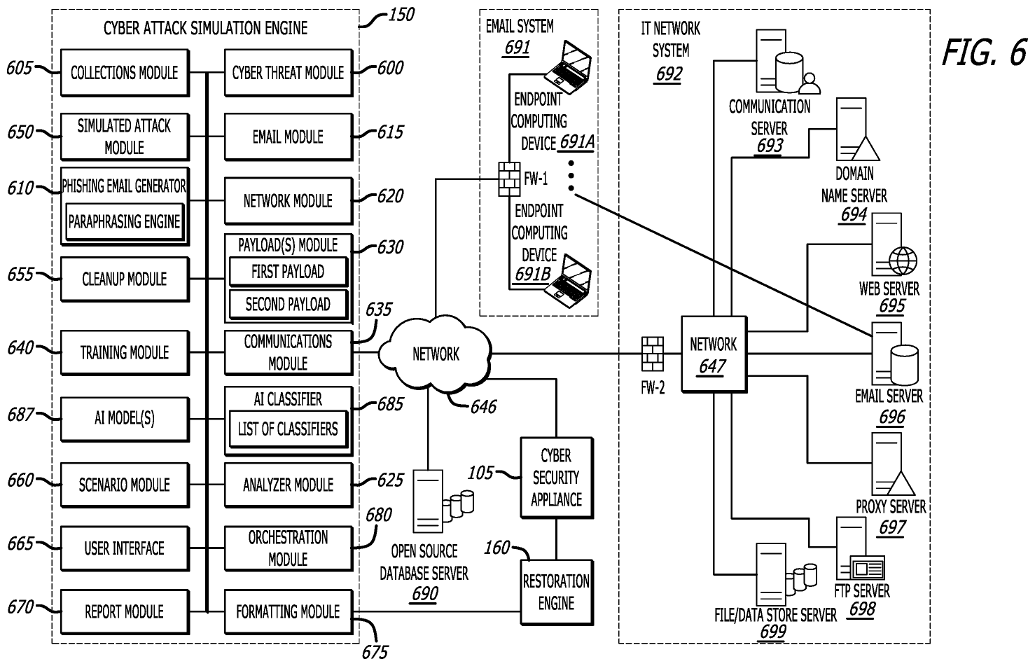

FIG. 6 illustrates a block diagram of an embodiment of the cyberattack simulation engine 150 with AI-based simulations conducted in the cyberattack simulation engine by constructing a graph of nodes of the system being protected (e.g. a network including i) the physical devices connecting to the network, any virtualized instances of the network, user accounts in the network, email accounts in the network, etc. as well as ii) connections and pathways through the network) to create a virtualized instance of the network to be tested. As shown in FIG. 6, the various cooperating modules residing in the cyberattack simulation engine 150 may include, but are not limited to, a collections module 605, a cyberattack generator (e.g. phishing email generator with a paraphrasing engine) 610, an email module 615, a network module 620, an analyzer module 625, a payloads module 630 with first and second payloads, a communication module 635, a training module 640, a simulated attack module 650, a cleanup module 655, a scenario module 660, a user interface 665, a reporting module 670, a formatting module 675, an orchestration module 680, and/or an AI classifier 685 with a list of specified classifiers.

The cyberattack simulation engine 150 may be implemented via i) a simulator to model the system being protected and/or ii) a clone creator to spin up a virtual network and create a virtual clone of the system being protected configured to pentest one or more defenses provided by scores based on both the level of confidence that the cyber threat is a viable threat and the severity of the cyber threat (e.g., attack type where ransomware attacks has greater severity than phishing attack; degree of infection; computing devices likely to be targeted, etc.). The threat risk scores be used to rank alerts that may be directed to enterprise or computing device administrators. This risk assessment and ranking is conducted to avoid frequent “false positive” alerts that diminish the degree of reliance/confidence on the cybersecurity appliance 105.

The cyberattack simulation engine 150 may include and cooperate with one or more AI models 687 trained with machine learning on the contextual knowledge of the organization. These trained AI models 687 may be configured to identify data points from the contextual knowledge of the organization and its entities, which may include, but is not limited to, language-based data, email/network connectivity and behavior pattern data, and/or historic knowledgebase data. The cyberattack simulation engine 150 may use the trained AI models to cooperate with one or more AI classifier(s) by producing a list of specific organization-based classifiers for the AI classifier. The cyberattack simulation engine 150 is further configured to calculate, based at least in part on the results of one or more hypothetical simulations of a possible cyberattack and/or of an actual ongoing cyberattack from a cyber threat determine a risk score for each node (e.g. each device, user account, etc.), the threat risk score being indicative of a possible severity of the compromise prior to an autonomous response action is taken in response to the actual cyberattack of the cyber incident.

Referring to FIG. 7, an illustrative diagram of an embodiment of the cyberattack simulation engine 150 and its AI-based simulations 700 constructing an exemplary graph of nodes in an example network and simulating how the cyberattack might likely progress in the future tailored with an innate understanding of a normal behavior of the nodes in the system being protected and a current operational state of each node in the graph of the protected system during simulations of cyberattacks. The cyberattack simulation engine 150 plots the attack path through the nodes and estimated times to reach critical nodes in the network. The cyberattack simulation modeling is run to identify the routes, difficulty, and time periods from certain entry notes to certain key servers.

Again, similarly named components in each AI-based engine can 1) perform similar functions and/or 2) have a communication link from that component located in one of the AI-based engines and then information is needed from that component is communicated to another AI-based engine that through the interface to that AI-based engine.

### Training of AI Pre-Deployment/Deployment

Referring back to FIG. 3, the initial training of an AI model trained on cyber threats can occur using unsupervised learning and/or supervised learning on characteristics and attributes of known potential cyber threats including malware, insider threats, and other kinds of cyber threats that can occur within that domain. Each Artificial Intelligence can be programmed and configured with the background information to understand and handle particulars, including different types of data, protocols used, types of devices, user accounts, etc. of the system being protected. The AI model pre-deployment can all be trained on the specific machine learning task that they will perform when put into deployment. For example, the AI model, such as one or more AI models or rule-based modules for example (i.e., the model(s) 360 described above), trained on identifying a specific cyber threat learns at least both in the pre-deployment training i) the characteristics and attributes of known potential cyber threats as well as ii) a set of characteristics and attributes of each category of potential cyber threats and their weights assigned on how indicative certain characteristics and attributes correlate to potential cyber threats of that category of threats. In this example, one of the model(s) 360 trained on identifying a specific cyber threat can be trained with machine learning such as Linear Regression, Regression Trees, Non-Linear Regression, Bayesian Linear Regression, Deep learning, etc. to learn and understand the characteristics and attributes in that category of cyber threats. Later, when in deployment in a domain/network being protected by the cybersecurity appliance 105, the AI model trained on cyber threats can determine whether a potentially unknown threat has been detected via a number of techniques including an overlap of some of the same characteristics and attributes in that category of cyber threats. The AI model may use unsupervised learning when deployed to better learn newer and updated characteristics of cyberattacks.

In an embodiment, one or more of the AI models 360 may be trained on a normal pattern of life of entities in the system are self-learning AI model using unsupervised machine learning and machine learning algorithms to analyze patterns and ‘learn’ what is the ‘normal behavior’ of the network by analyzing data on the activity on, for example, the network level, at the device level, and at the employee level. The self-learning AI model using unsupervised machine learning understands the system under analysis' normal patterns of life in, for example, a week of being deployed on that system, and grows more bespoke with every passing minute. The AI unsupervised learning model learns patterns from the features in the day-to-day dataset and detecting abnormal data which would not have fallen into the category (cluster) of normal behavior. The self-learning AI model using unsupervised machine learning can simply be placed into an observation mode for an initial week or two when first deployed on a network/domain in order to establish an initial normal behavior for entities in the network/domain under analysis.

Thus, a deployed AI model trained on a normal behavior of entities in the system can be configured to observe the nodes in the system being protected. Training on the normal behavior of entities in the system can occur while monitoring for the first week or two until enough data has been observed to establish a statistically reliable set of normal operations for each node (e.g., user account, device, etc.). Initial training of one or more AI models of the model(s) 360 with machine learning on a normal behavior of the pattern of life of the entities in the network/domain can occur where each type of network and/or domain will generally have some common typical behavior with each model trained specifically to understand components/devices, protocols, activity level, etc. to that type of network/system/domain. Alternatively, pre-deployment machine learning training of one or more AI models trained on a normal pattern of life of entities in the system can occur. Initial training of one or more AI models with machine learning on a behavior of the pattern of life of the entities in the network/domain can occur where each type of network and/or domain will generally have some common typical behavior with each model trained specifically to understand components/devices, protocols, activity level, etc. to that type of network/system/domain. What is normal behavior of each entity within that system can be established either prior to deployment and then adjusted during deployment or alternatively the model can simply be placed into an observation mode for an initial week or two when first deployed on a network/domain in order to establish an initial normal behavior for entities in the network/domain under analysis. During deployment, what is considered normal behavior will change as each different entity's behavior changes and will be reflected through the use of unsupervised learning in the model such as various Bayesian techniques, clustering, etc. The AI models can be implemented with various mechanisms such neural networks, decision trees, etc. and combinations of these. Likewise, one or more supervised machine learning AI models may be trained to create possible hypotheses and perform cyber threat investigations on agnostic examples of past historical incidents of detecting a multitude of possible types of cyber threat hypotheses previously analyzed by human cybersecurity analyst. More on the training of AI models are trained to create one or more possible hypotheses and perform cyber threat investigations will be discussed later.

At its core, the first (self-learning) AI model 361 that represents the normal behavior (e.g. a normal pattern of life) of entities in the network mathematically characterizes what constitutes ‘normal’ behavior, based on the analysis of a large number of different measures of a device's network behavior-packet traffic and network activity/processes including server access, data volumes, timings of events, credential use, connection type, volume, and directionality of, for example, uploads/downloads into the network, file type, packet intention, admin activity, resource and information requests, command sent, etc.

### Clustering Methods

In order to model what should be considered as normal for a device or cloud container, its behavior can be analyzed in the context of other similar entities on the network. The AI models deployed as part of the model(s) 360 can use unsupervised machine learning to algorithmically identify significant groupings, a task which is virtually impossible to do manually. To create a holistic image of the relationships within the network, the AI models and AI classifiers employ a number of different clustering methods, including matrix-based clustering, density-based clustering, and hierarchical clustering techniques. The resulting clusters can then be used, for example, to inform the modeling of the normative behaviors and/or similar groupings.

The AI models and AI classifiers can employ a large-scale computational approach to understand sparse structure in models of network connectivity based on applying L1-regularization techniques (the lasso method). This allows the artificial intelligence to discover true associations between different elements of a network which can be cast as efficiently solvable convex optimization problems and yield parsimonious models. Various mathematical approaches assist.

Next, one or more supervised machine learning AI models are trained to create possible hypotheses and how to perform cyber threat investigations on agnostic examples of past historical incidents of detecting a multitude of possible types of cyber threat hypotheses previously analyzed by human cyber threat analysis. AI models trained on forming and investigating hypotheses on what is a possible set of cyber threats can be trained initially with supervised learning. Thus, these AI models can be trained on how to form and investigate hypotheses on what is a possible set of cyber threats and steps to take in supporting or refuting hypotheses. The AI models trained on forming and investigating hypotheses are updated with unsupervised machine learning algorithms when correctly supporting or refuting the hypotheses, including what additional collected data proved to be the most useful. More on the training of the AI models that are trained to create one or more possible hypotheses and perform cyber threat investigations will be discussed later.

Next, the various AI models and AI classifiers combine use of unsupervised and supervised machine learning to learn ‘on the job’—it does not depend upon solely knowledge of previous cyber threat attacks. The AI models and classifiers combine use of unsupervised and supervised machine learning constantly revises assumptions about behavior, using probabilistic mathematics, that is always up to date on what a current normal behavior is, and not solely reliant on human input. The AI models and classifiers combine use of unsupervised and supervised machine learning on cybersecurity is capable of seeing hitherto undiscovered cyber events, from a variety of threat sources, which would otherwise have gone unnoticed.

Next, these cyber threats can include, for example: Insider threat-malicious or accidental, Zero-day attacks-previously unseen, novel exploits, latent vulnerabilities, machine-speed attacks-ransomware and other automated attacks that propagate and/or mutate very quickly, Cloud and SaaS-based attacks, other silent and stealthy attacks advance persistent threats, advanced spear-phishing, etc.

### Ranking the Cyber Threat

The assessment module 325 and/or cyber threat analyst module 320 of FIG. 3 can cooperate with the model(s) 360 trained on possible cyber threats to use AI algorithms to account for ambiguities by distinguishing between the subtly differing levels of evidence that characterize network data. Instead of generating the simple binary outputs ‘malicious’ or ‘benign’, the AI's mathematical algorithms produce outputs marked with differing degrees of potential threat. This enables users of the system to rank alerts and notifications to the enterprise security administrator in a rigorous manner and prioritize those which most urgently require action. Meanwhile, it also assists to avoid the problem of numerous false positives associated with simply a rule-based approach.

### Additional Cybersecurity Appliance Operability

As discussed in more detail below, the analyzer module 315 and/or cyber threat analyst module 320 can cooperate with the one or more unsupervised AI (machine learning) models being part of the model(s) 360, which are trained on the normal pattern of life/normal behavior in order to perform anomaly detection against the actual normal pattern of life for that system to determine whether an anomaly (e.g., the identified abnormal behavior and/or suspicious activity) is malicious or benign. In the operation of the cybersecurity appliance 105, the emerging cyber threat can be previously unknown, but the emerging threat landscape data representative of the emerging cyber threat shares enough (or does not share enough) in common with the traits from the AI models trained on cyber threats to now be identified as malicious or benign. Note, if later confirmed as malicious, then the AI models trained with machine learning on possible cyber threats can update their training. Likewise, as the cybersecurity appliance 105 continues to operate, then the one or more AI models trained on a normal pattern of life for each of the entities in the system can be updated and trained with unsupervised machine learning algorithms. The analyzer module 315 can use any number of data analysis processes to help obtain system data points so that this data can be fed and compared to the one or more AI models trained on a normal pattern of life, as well as the one or more machine learning models trained on potential cyber threats, as well as create and store data points with the connection fingerprints.

All of the above-described AI models can continually learn and train with unsupervised machine learning algorithms on an ongoing basis when deployed in their system that the cybersecurity appliance 105 is protecting. Thus, learning and training on what is normal behavior for each user, each device, and the system overall and lowering a threshold of what is an anomaly.

### Anomaly Detection/Deviations

Anomaly detection can discover unusual data points in your dataset. Anomaly can be a synonym for the word ‘outlier.’ Anomaly detection (or outlier detection) is the identification of rare items, events or observations which raise suspicions by differing significantly from the majority of the data. Anomalous activities can be linked to some kind of problems or rare events. Since there are tons of ways to induce a particular cyberattack, it is very difficult to have information about all these attacks beforehand in a dataset. But, since the majority of the user activity and device activity in the system under analysis is normal, the system overtime captures almost all of the ways which indicate normal behavior. And from the inclusion-exclusion principle, if an activity under scrutiny does not give indications of normal activity, the self-learning AI model using unsupervised machine learning can predict with high confidence that the given activity is anomalous. The AI unsupervised learning model learns patterns from the features in the day-to-day dataset and detecting abnormal data which would not have fallen into the category (cluster) of normal behavior. The goal of the anomaly detection algorithm through the data fed to it is to learn the patterns of a normal activity so that when an anomalous activity occurs, the modules can flag the anomalies through the inclusion-exclusion principle. The goal of the anomaly detection algorithm through the data fed to it is to learn the patterns of a normal activity so that when an anomalous activity occurs, the modules can flag the anomalies through the inclusion-exclusion principle. The cyber threat module can perform its two-level analysis on anomalous behavior and determine correlations.

In an example, 95% of data in a normal distribution lies within two standard-deviations from the mean. Since the likelihood of anomalies in general is very low, the modules cooperating with the AI model of normal behavior can say with high confidence that data points spread near the mean value are non-anomalous. And since the probability distribution values between mean and two standard-deviations are large enough, the modules cooperating with the AI model of normal behavior can set a value in this example range as a threshold (a parameter that can be tuned over time through the self-learning), where feature values with probability larger than this threshold indicate that the given feature's values are non-anomalous, otherwise it's anomalous. Note, this anomaly detection can determine that a data point is anomalous/non-anomalous on the basis of a particular feature. In reality, the cybersecurity appliance 105 should not flag a data point as an anomaly based on a single feature. Merely, when a combination of all the probability values for all features for a given data point is calculated can the modules cooperating with the AI model of normal behavior can say with high confidence whether a data point is an anomaly or not. Anomaly detection can discover unusual data points in your dataset. Anomaly can sometimes be a synonym for the word ‘outlier.’

Again, the AI models trained on a normal pattern of life of entities in a network (e.g., domain) under analysis may perform the cyber threat detection through a probabilistic change in a normal behavior through the application of, for example, an unsupervised Bayesian mathematical model to detect the behavioral change in computers and computer networks. The Bayesian probabilistic approach can determine periodicity in multiple time series data and identify changes across single and multiple time series data for the purpose of anomalous behavior detection. Please reference U.S. Pat. No. 30,701,093 granted Jun. 30, 2020, titled “Anomaly alert system for cyber threat detection” for an example Bayesian probabilistic approach, which is incorporated by reference in its entirety. In addition, please reference US patent publication number “US2021273958A1 filed Feb. 26, 2021, titled “Multi-stage anomaly detection for process chains in multi-host environments” for another example anomalous behavior detector using a recurrent neural network and a bidirectional long short-term memory (LSTM), which is incorporated by reference in its entirety. In addition, please reference US patent publication number “US2020244673A1, filed Apr. 23, 2019, titled “Multivariate network structure anomaly detector,” which is incorporated by reference in its entirety, for another example of anomalous behavior detector with a Multivariate Network and Artificial Intelligence classifiers.

Next, as discussed further below, during pre-deployment, the cyber threat analyst module 320 and the analyzer module 315 can use data analysis processes and cooperate with the model(s) 360 trained on forming and investigating hypotheses on what is a possible set of cyber threats. In addition, another set of AI models can be trained on how to form and investigate hypotheses on what is a possible set of cyber threats and steps to take in supporting or refuting hypotheses. The AI models trained on forming and investigating hypotheses are updated with unsupervised machine learning algorithms when correctly supporting or refuting the hypotheses including what additional collected data proved to be the most useful.

Similarly, during deployment, the data analysis processes (discussed herein) used by the analyzer module 315 can use unsupervised machine learning to update the initial training learned during pre-deployment, and then update the training with unsupervised learning algorithms during the cybersecurity appliance's 105 deployment in the system being protected when various different steps to either i) support or ii) refute the possible set of cyber threats hypotheses worked better or worked worse.

The model(s) 360 trained on a normal pattern of life of entities in a domain under analysis may perform the threat detection through a probabilistic change in a normal behavior through the application of, for example, an unsupervised Bayesian mathematical model to detect a behavioral change in computers and computer networks. The Bayesian probabilistic approach can determine periodicity in multiple time series data and identify changes across single and multiple time series data for the purpose of anomalous behavior detection. In an example, a system being protected can include both email and IT network domains under analysis. Thus, email and IT network raw sources of data can be examined along with a large number of derived metrics that each produce time series data for the given metric.

### Additional Module Interactions

Referring still to FIG. 3, the gather module 310 cooperates with the data store 350. The data store 350 stores comprehensive logs for network traffic observed. These logs can be filtered with complex logical queries and each IP packet can be interrogated on a vast number of metrics in the network information stored in the data store. Similarly, other domain's communications and data, such as emails, logs, etc. may be collected and stored in the data store 350. The gather module 310 may consist of multiple automatic data gatherers that each look at different aspects of the data depending on the hypothesis formed for the analysed event. The data relevant to each type of possible hypothesis can be automatically pulled from additional external and internal sources. Some data is pulled or retrieved by the gather module 310 for each possible hypothesis.

The data store 350 can store the metrics and previous threat alerts associated with network traffic for a period of time, which is, by default, at least 27 days. This corpus of data is fully searchable. The cybersecurity appliance 105 works with network probes to monitor network traffic and store and record the data and metadata associated with the network traffic in the data store.

The gather module 310 may have a process identifier classifier. The process identifier classifier can identify and track each process and device in the network, under analysis, making communication connections. The data store 350 cooperates with the process identifier classifier to collect and maintain historical data of processes and their connections, which is updated over time as the network is in operation. In an example, the process identifier classifier can identify each process running on a given device along with its endpoint connections, which are stored in the data store. Similarly, data from any of the domains under analysis may be collected and compared.

Examples of domains/networks under analysis being protected can include any of i) an Informational Technology network, ii) an Operational Technology network, iii) a Cloud service, iv) a SaaS service, v) an endpoint device, vi) an email domain, and vii) any combinations of these. A domain module is constructed and coded to interact with and understand a specific domain.

For instance, the first domain module 330 may operate as an IT network module configured to receive information from and send information to, in this example, IT network-based sensors (i.e., probes, taps, etc.). The first domain module 330 also has algorithms and components configured to understand, in this example, IT network parameters, IT network protocols, IT network activity, and other IT network characteristics of the network under analysis. The second domain module 335 is, in this example, an email module. The second domain module 335 can be an email network module configured to receive information from and send information to, in this example, email-based sensors (i.e., probes, taps, etc.). The second domain module 335 also has algorithms and components configured to understand, in this example, email parameters, email protocols and formats, email activity, and other email characteristics of the network under analysis. Additional domain modules can also collect domain data from another respective domain.

The coordinator module 340 is configured to work with various machine learning algorithms and relational mechanisms to i) assess, ii) annotate, and/or iii) position in a vector diagram, a directed graph, a relational database, etc., activity including events occurring, for example, in the first domain compared to activity including events occurring in the second domain. The domain modules 330/335 can cooperate to exchange and store their information with the data store.

The process identifier classifier (not shown) in the gather module 310 can cooperate with additional classifiers in each of the domain modules 330/335 to assist in tracking individual processes and associating them with entities in a domain under analysis as well as individual processes and how they relate to each other. The process identifier classifier can cooperate with other trained AI classifiers in the modules to supply useful metadata along with helping to make logical nexuses.

A feedback loop of cooperation exists between the gather module 310, the analyzer module 315, model(s) 360 trained on different aspects of this process, and the cyber threat analyst module 320 to gather information to determine whether a cyber threat is potentially attacking the networks/domains under analysis.

### Determination Likelihood of Maliciousness

In the following examples the analyzer module 315 and/or cyber threat analyst module 320 can use multiple factors to the determination of whether a process, event, object, entity, etc. is likely malicious.

In an example, the analyzer module 315 and/or cyber threat analyst module 320 can cooperate with one or more of the model(s) 360 trained on certain cyber threats to detect whether the anomalous activity detected, such as suspicious email messages, exhibit traits that may suggest a malicious intent, such as phishing links, scam language, sent from suspicious domains, etc. The analyzer module 315 and/or cyber threat analyst module 320 can also cooperate with one of more of the model(s) 360 trained on potential IT based cyber threats to detect whether the anomalous activity detected, such as suspicious IT links, URLs, domains, user activity, etc., may suggest a malicious intent as indicated by the AI models trained on potential IT based cyber threats.

In the above example, the analyzer module 315 and/or the cyber threat analyst module 320 can cooperate with the one or more AI models (e.g., AI model 361) trained with machine learning on the normal pattern of life for entities in an email domain under analysis to detect, in this example, anomalous emails which are detected as outside of the usual pattern of life for each entity, such as a user, email server, etc., of the email network/domain. Likewise, the analyzer module 315 and/or the cyber threat analyst module 320 can cooperate with the one or more AI models (not shown) trained with machine learning on the normal pattern of life for entities in a second domain under analysis (in this example, an IT network) to detect, in this example, anomalous network activity by user and/or devices in the network, which is detected as outside of the usual pattern of life (e.g. abnormal) for each entity, such as a user or a device, of the second domain's network under analysis.

Thus, the analyzer module 315 and/or the cyber threat analyst module 320 can be configured with one or more data analysis processes to cooperate with the model(s) 360 trained with machine learning on the normal pattern of life in the system, to identify an anomaly of at least one of i) the abnormal behavior, ii) the suspicious activity, and iii) the combination of both, from one or more entities in the system. Note, other sources, such as other model breaches, can also identify at least one of i) the abnormal behavior, ii) the suspicious activity, and iii) the combination of both to trigger the investigation.

Accordingly, during this cyber threat determination process, the analyzer module 315 and/or the cyber threat analyst module 320 can also use AI classifiers that look at the features and determine a potential maliciousness based on commonality or overlap with known characteristics of malicious processes/entities. Many factors including anomalies that include unusual and suspicious behavior, and other indicators of processes and events are examined by the second AI model 362 of the model(s) 360 trained on potential cyber threats and/or the AI classifiers looking at specific features for their malicious nature in order to make a determination of whether an individual factor and/or whether a chain of anomalies is determined to be likely malicious.

Initially, in this example of activity in an IT network analysis, the rare JA3 hash and/or rare user agent connections for this network coming from a new or unusual process are factored just like in the first wireless domain suspicious wireless signals are considered. These are quickly determined by referencing the one or more of the model(s) 360 trained with machine learning on the pattern of life of each device and its associated processes in the system. Next, the analyzer module 315 and/or the cyber threat analyst module 320 can have an external input to ingest threat intelligence from other devices in the network cooperating with the cybersecurity appliance 105. Next, the analyzer module 315 and/or the cyber threat analyst module 320 can look for other anomalies, such as model breaches, while the AI models trained on potential cyber threats can assist in examining and factoring other anomalies that have occurred over a given timeframe to see if a correlation exists between a series of two or more anomalies occurring within that time frame.

The analyzer module 315 and/or the cyber threat analyst module 320 can combine these Indicators of Compromise (e.g., unusual network JA3, unusual device JA3, . . . ) with many other weak indicators to detect the earliest signs of an emerging threat, including previously unknown threats, without using strict blacklists or hard-coded thresholds. However, the AI classifiers can also routinely look at blacklists, etc. to identify maliciousness of features looked at.

Another example of features may include a deeper analysis of endpoint data. This endpoint data may include domain metadata, which can reveal peculiarities such as one or more indicators of potentially a malicious domain (i.e., its URL). The deeper analysis may assist in confirming an analysis to determine that indeed a cyber threat has been detected. The analyzer module 315 can also look at factors of how rare the endpoint connection is, how old the endpoint is, where geographically the endpoint is located, how a security certificate associated with a communication is verified only by an endpoint device or by an external 3rd party, just to name a few additional factors. The analyzer module 315 (and similarly the cyber threat analyst module 320) can then assign weighting given to these factors in the machine learning that can be supervised based on how strongly that characteristic has been found to match up to actual malicious sites in the training.

In another AI classifier to find potentially malicious indicators, the agent analyzer data analysis process in the analyzer module 315 and/or cyber threat analyst module 320 may cooperate with the process identifier classifier to identify all of the additional factors of i) are one or more processes running independently of other processes, ii) are the one or more processes running independent are recent to this network, and iii) are the one or more processes running independent connect to the endpoint, which the endpoint is a rare connection for this network, which are referenced and compared to one or more AI models trained with machine learning on the normal behavior of the pattern of life of the system.

Note, a user agent, such as a browser, can act as a client in a network protocol used in communications within a client-server distributed computing system. In particular, the Hypertext Transfer Protocol (HTTP) identifies the client software originating (an example user agent) the request, using a user-agent header, even when the client is not operated by a user. Note, this identification can be faked, so it is only a weak indicator of the software on its own, but when compared to other observed user agents on the device, this can be used to identify possible software processes responsible for requests.

The analyzer module 315 and/or the cyber threat analyst module 320 may use the agent analyzer data analysis process that detects a potentially malicious agent previously unknown to the system to start an investigation on one or more possible cyber threat hypotheses. The determination and output of this step is what are possible cyber threats that can include or be indicated by the identified abnormal behavior and/or identified suspicious activity identified by the agent analyzer data analysis process.

In an example, the cyber threat analyst module 320 can use the agent analyzer data analysis process and the AI models(s) trained on forming and investigating hypotheses on what are a possible set of cyber threats to use the machine learning and/or set scripts to aid in forming one or more hypotheses to support or refute each hypothesis. The cyber threat analyst module 320 can cooperate with one or more of the AI models trained on forming and investigating hypotheses (e.g., third AI model 363) to form an initial set of possible hypotheses, which needs to be intelligently filtered down. The cyber threat analyst module 320 can be configured to use the one or more supervised machine learning models trained on i) agnostic examples of a past history of detection of a multitude of possible types of cyber threat hypotheses previously analyzed by human, who was a cybersecurity professional, ii) a behavior and input of how a plurality of human cybersecurity analysts make a decision and analyze a risk level regarding and a probability of a potential cyber threat, iii) steps to take to conduct an investigation start with anomaly via learning how expert humans tackle investigations into specific real and synthesized cyber threats and then the steps taken by the human cybersecurity professional to narrow down and identify a potential cyber threat, and iv) what type of data and metrics that were helpful to further support or refute each of the types of cyber threats, in order to determine a likelihood of whether the abnormal behavior and/or suspicious activity is either i) malicious or ii) benign.

The cyber threat analyst module 320 using AI models, scripts and/or rules based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

The cyber threat analyst module 320 using AI models, scripts and/or rules-based modules is configured to conduct initial investigations regarding the anomaly of interest, collected additional information to form a chain of potentially related/linked information under analysis and then form one or more hypotheses that could have this chain of information that is potentially related/linked under analysis and then gather additional information in order to refute or support each of the one or more hypotheses.

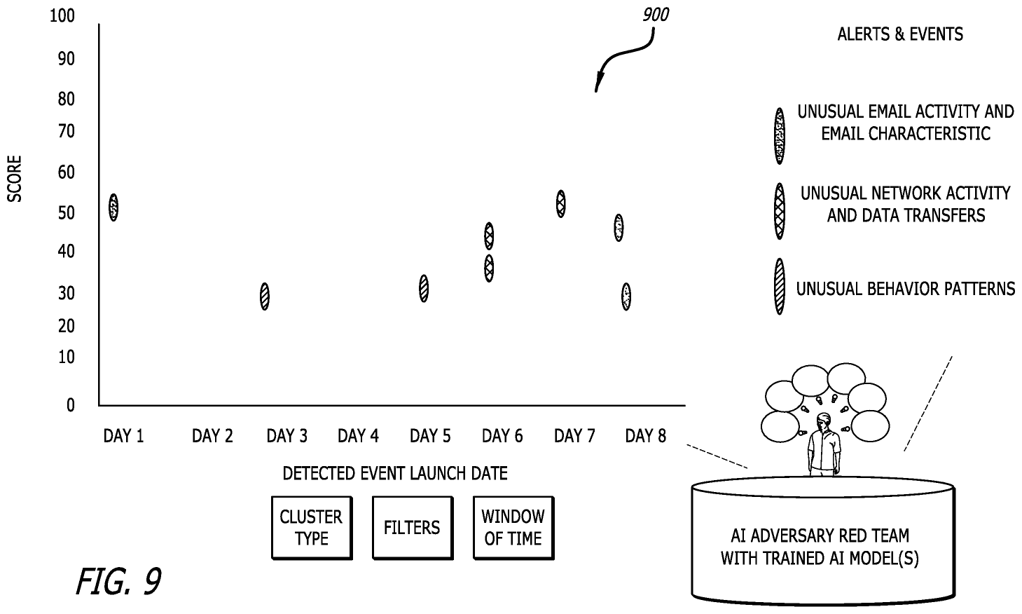

In an example, a behavioural pattern analysis of what are the unusual behaviours of the network/system/device/user under analysis by the machine learning models may be as follows. The coordinator module can tie the alerts, activities, and events from, in this example, the email domain to the alerts, activities, and events from the IT network domain. FIG. 9 illustrates a graph 900 of an embodiment of an example chain of unusual behaviour for, in this example, the email activities and IT network activities deviating from a normal pattern of life in connection with the rest of the system/network under analysis. The cyber threat analyst module and/or analyzer module can cooperate with one or more machine learning models. The one or more machine learning models are trained and otherwise configured with mathematical algorithms to infer, for the cyber-threat analysis, ‘what is possibly happening with the chain of distinct alerts, activities, and/or events, which came from the unusual pattern,’ and then assign a threat risk associated with that distinct item of the chain of alerts and/or events forming the unusual pattern. The unusual pattern can be determined by examining initially what activities/events/alerts that do not fall within the window of what is the normal pattern of life for that network/system/device/user under analysis can be analysed to determine whether that activity is unusual or suspicious. A chain of related activity that can include both unusual activity and activity within a pattern of normal life for that entity can be formed and checked against individual cyber threat hypothesis to determine whether that pattern is indicative of a behaviour of a malicious actor-human, program, or other threat. The cyber threat analyst module can go back and pull in some of the normal activities to help support or refute a possible hypothesis of whether that pattern is indicative of a behavior of a malicious actor. An example behavioral pattern included in the chain is shown in the graph over a time frame of, an example, 8 days. The cyber threat analyst module detects a chain of anomalous behavior of unusual data transfers three times, unusual characteristics in emails in the monitored system three times which seem to have some causal link to the unusual data transfers. Likewise, twice unusual credentials attempted the unusual behavior of trying to gain access to sensitive areas or malicious IP addresses and the user associated with the unusual credentials trying unusual behavior has a causal link to at least one of those three emails with unusual characteristics. Again, the cybersecurity appliance 105 of FIGS. 1 & 3 can go back and pull in some of the normal activities to help support or refute a possible hypothesis of whether that pattern is indicative of a behaviour of a malicious actor. The analyser module can cooperate with one or more models trained on cyber threats and their behaviour to try to determine if a potential cyber threat is causing these unusual behaviours. The cyber threat analyst module can put data and entities into 1) a directed graph and nodes in that graph that are overlapping or close in distance have a good possibility of being related in some manner, 2) a vector diagram, 3) a relational database, and 4) other relational techniques that will at least be examined to assist in creating the chain of related activity connected by causal links, such as similar time, similar entity and/or type of entity involved, similar activity, etc., under analysis. If the pattern of behaviours under analysis is believed to be indicative of a malicious actor, then a score of how confident the system in this assessment of is identifying whether the unusual pattern was caused by a malicious actor. Next, also assigned is a threat level score or probability indicative of what level of threat does this malicious actor pose. Lastly, the cybersecurity appliance 105 of FIGS. 1 & 3 is configurable in a user interface, by a user, enabling what type of automatic response actions, if any, the cybersecurity appliance 105 may take when different types of cyber threats, indicated by the pattern of behaviours under analysis, that are equal to or above a configurable level of threat posed by this malicious actor.

The autonomous response engine 140 of FIGS. 1 & 3 is configured to take one or more autonomous mitigation actions to mitigate the cyber threat during the cyberattack by the cyber threat. The autonomous response engine 140 is configured to reference an AI model trained to track a normal pattern of life for each node of the protected system to perform an autonomous act of restricting a potentially compromised node having i) an actual indication of compromise and/or ii) merely adjacent to a known compromised node, to merely take actions that are within that node's normal pattern of life to mitigate the cyber threat. Similarly named components in the cyberattack restoration engine 160 of FIG. 1 can operate and function similar to as described for the detection engine.

The chain of the individual alerts, activities, and events that form the pattern including one or more unusual or suspicious activities into a distinct item for cyber-threat analysis of that chain of distinct alerts, activities, and/or events. The cyber-threat module may reference the one or more machine learning models trained on, in this example, e-mail threats to identify similar characteristics from the individual alerts and/or events forming the distinct item made up of the chain of alerts and/or events forming the unusual pattern.

### Cyber Threat Assessment for Autonomous Action Determination

In the next step, as shown in FIG. 3, the analyzer module 315 and/or cyber threat analyst module 320 of the cyber threat detection engine 130 generates one or more supported possible cyber threat hypotheses from the possible set of cyber threat hypotheses. The analyzer module 315 generates the supporting data and details of why each individual hypothesis is supported or not. The analyzer module 315 can also generate one or more possible cyber threat hypotheses and the supporting data and details of why they were refuted.

In general, the analyzer module 315 cooperates with the following three sources. The analyzer module 315 cooperates with the AI models trained on cyber threats (e.g., second AI model 362) to determine whether an anomaly such as the abnormal behavior and/or suspicious activity is either 1) malicious or 2) benign when the potential cyber threat under analysis is previously unknown to the cybersecurity appliance 105. The analyzer module 315 cooperates with the AI models trained on a normal behavior of entities in the network under analysis (e.g., AI model 361). The analyzer module 315 cooperates with various AI-trained classifiers. With all of these sources, when they input information that indicates a potential cyber threat that is i) severe enough to cause real harm to the network under analysis and/or ii) a close match to known cyber threats, then the analyzer module can make a final determination to confirm that a cyber threat likely exists and send that cyber threat to the assessment module to assess the threat score associated with that cyber threat. Certain model breaches will always trigger a potential cyber threat that the analyzer will compare and confirm the cyber threat.

In the next step, an assessment module 325 with the AI classifiers is configured to cooperate with the analyzer module 315. The analyzer module 315 supplies the identity of the supported possible cyber threat hypotheses from the possible set of cyber threat hypotheses to the assessment module. The assessment module 325 with the AI classifiers cooperates with the second AI model 362 (AI model trained on possible cyber threats) can make a determination on whether a cyber threat exists and what level of severity is associated with that cyber threat. The assessment module 325 with the AI classifiers cooperates with the one or more AI models trained on possible cyber threats in order to assign a numerical assessment of a given cyber threat hypothesis that was found likely to be supported by the analyzer module with the one or more data analysis processes, via the abnormal behavior, the suspicious activity, or the collection of system data points. The assessment module 325 with the AI classifiers output can be a score (ranked number system, probability, etc.) that a given identified process is likely a malicious process.

The assessment module 325 with the AI classifiers can be configured to assign a numerical assessment, such as a probability, of a given cyber threat hypothesis that is supported and a threat level posed by that cyber threat hypothesis which was found likely to be supported by the analyzer module 315, which includes the abnormal behavior or suspicious activity as well as one or more of the collection of system data points, with the one or more AI models trained on possible cyber threats.

The cyber threat analyst module 320 in the cybersecurity appliance 105 component provides an advantage over competitors' products as it reduces the time taken for cybersecurity investigations, provides an alternative to manpower for small organizations and improves detection (and remediation) capabilities within the cybersecurity platform.

The AI-based cyber threat analyst module 320 performs its own computation of threat and identifies interesting network events with one or more processers. These methods of detection and identification of threat all add to the above capabilities that make the AI-based cyber threat analyst module 320 a desirable part of the cybersecurity appliance 105. The AI-based cyber threat analyst module 320 offers a method of prioritizing which is not just a summary or highest score alert of an event evaluated by itself equals the worst, and prevents more complex attacks being missed because their composite parts/individual threats only produced low-level alerts.

The AI classifiers can be part of the assessment module 325, which scores the outputs of the analyzer module 315. Again, as for the other AI classifiers discussed, the AI classifier can be coded to take in multiple pieces of information about an entity, object, and/or thing and based on its training and then output a prediction about the entity, object, or thing. Given one or more inputs, the AI classifier model will try to predict the value of one or more outcomes. The AI classifiers cooperate with the range of data analysis processes that produce features for the AI classifiers. The various techniques cooperating here allow anomaly detection and assessment of a cyber threat level posed by a given anomaly; but more importantly, an overall cyber threat level posed by a series/chain of correlated anomalies under analysis.

In the next step, the user interface/formatting module 345 can generate an output such as a printed or electronic report with the relevant data. The user interface/formatting module 345 can cooperate with both the analyzer module 315 and the assessment module 325 depending on what the user wants to be reported.

The user interface/formatting module 345 is configured to format, present a rank for, and output one or more supported possible cyber threat hypotheses from the assessment module 325 into a formalized report, from one or more report templates populated with the data for that incident.

The user interface/formatting module 345 is configured to format, present a rank for, and output one or more detected cyber threats from the analyzer module 315 or from the assessment module 325 into a formalized report, from one or more report templates populated with the data for that incident. Many different types of formalized report templates exist to be populated with data and can be outputted in an easily understandable format for a human user's consumption.

The formalized report on the template is outputted for a human user's consumption in a medium of any of 1) printable report, 2) presented digitally on a user interface, 3) in a machine-readable format for further use in machine-learning reinforcement and refinement, or 4) any combination of the three. The user interface/formatting module 345 is further configured to generate a textual write up of an incident report in the formalized report for a wide range of breaches of normal behavior, used by the AI models trained with machine learning on the normal behavior of the system, based on analyzing previous reports with one or more models trained with machine learning on assessing and populating relevant data into the incident report corresponding to each possible cyber threat.

For instance, the user interface/formatting module 345 can generate a threat incident report in the formalized report from a multitude of a dynamic human-supplied and/or machine created templates corresponding to different types of cyber threats, each template corresponding to different types of cyber threats that vary in format, style, and standard fields in the multitude of templates. The user interface/formatting module 345 can also populate a given template with relevant data, graphs, or other information as appropriate in various specified fields, along with a ranking of a likelihood of whether that hypothesis cyber threat is supported and its threat severity level for each of the supported cyber threat hypotheses, and then output the formatted threat incident report with the ranking of each supported cyber threat hypothesis, which is presented digitally on the user interface and/or printed as the printable report.

In the next step, the assessment module 325 with the AI classifiers, once armed with the knowledge that malicious activity is likely occurring/is associated with a given process from the analyzer module 315, then cooperates with the autonomous response engine 140 to take an autonomous action such as i) deny access in or out of the device or the network and/or ii) shutdown activities involving a detected malicious agent.

The autonomous response engine 140, rather than a human taking an action, can be configured to cause one or more rapid autonomous mitigation actions to be taken to counter the cyber threat. A user interface for the response module can program the autonomous response engine 140 i) to merely make a suggested response to take to counter the cyber threat that will be presented on a display screen and/or sent by a notice to an administrator for explicit authorization when the cyber threat is detected or ii) to autonomously take a response to counter the cyber threat without a need for a human to approve the response when the cyber threat is detected. The autonomous response engine 140 will then send a notice of the autonomous response as well as display the autonomous response taken on the display screen. Example autonomous responses may include cut off connections, shutdown devices, change the privileges of users, delete, and remove malicious links in emails, slow down a transfer rate, and other autonomous actions against the devices and/or users.

The autonomous response engine 140 uses one or more AI models of the model(s) 360 that are configured to intelligently work with other third-party defense systems in that customer's network against threats. The autonomous response engine 140 can send its own protocol commands to devices and/or take actions on its own. In addition, the autonomous response engine 140 uses the one or more Artificial Intelligence models to orchestrate with other third-party defense systems to create a unified defense response against a detected threat within or external to that customer's network. The autonomous response engine 140 can be an autonomous self-learning response coordinator that is trained specifically to control and reconfigure the actions of traditional legacy computer defenses (e.g., firewalls, switches, proxy servers, etc.) to contain threats propagated by, or enabled by, networks and the internet. The cyber threat module 600 of the cyberattack simulation engine 150 of FIG. 6 can cooperate with the autonomous response engine 140 to cause one or more autonomous actions in response to be taken to counter the cyber threat, improves computing devices in the system by limiting an impact of the cyber threat from consuming unauthorized CPU cycles, memory space, and power consumption in the computing devices via responding to the cyber threat without waiting for some human intervention.

The trigger module 305, analyzer module 315, assessment module 325, and user interface/formatting module 345 cooperate to improve the analysis and formalized report generation with less repetition to consume CPU cycles with greater efficiency than humans repetitively going through these steps and re-duplicating steps to filter and rank the one or more supported possible cyber threat hypotheses from the possible set of cyber threat hypotheses.

Again, the multiple (e.g., four) AI-based engines 130, 140, 150 & 160 have communication hooks in between them to exchange a significant amount of behavioral metrics including data between these multiple AI-based engines to work in together to provide an overall cyber threat response. The AI adaptive incident response loop has interaction and orchestration between the multiple (four) self-learning AI components, each trained and focused on their individual machine-learned tasks of i) detecting a cyber threat, ii) how to conduct a simulation and make the prediction about a cyberattack, iii) how to make and what types of autonomous mitigation responses can be made in response to a cyberattack and iv) what level of restrictions are needed and how to invoke restoration actions to restore nodes in the system being protected while still mitigating effects of the cyberattack. The Artificial Intelligence in each of the engines trained and focused on performing their corresponding machine-learned tasks as well as the orchestration between the AI-based engines drive the exchange to make them work in together against a cyberattack by the cyber threat (e.g., malicious actor). The intelligent pre-processing component facilitates the multiple example stages of the Artificial Intelligence augmented and adaptive interactive response loop between these four AI-based engines.

As generally described above, the cyberattack simulation engine 150 after running the AI-based simulations communicates to the autonomous response engine 140 the locations where it could block the likely and/dangerous next moves by the attacker. The Artificial Intelligence in the autonomous response engine 140 analyzes the simulation results and grabs any additional information needed to decide what nodes need autonomous actions and what mitigation actions to take to each node that is compromised and potentially its neighboring nodes. The Artificial Intelligence in the autonomous response engine 140 reasons and takes action. The AI engines 130, 140, 150 and/or 160 also update the report visible to the human cybersecurity team.

The intelligent, pre-processing component 110 of FIGS. 1-3 uses unsupervised machine learning algorithms to self-learn from previous cyber threat incidents (and their aftermath) on tasks such as how the response went, what worked, what did not, how long things took and how this compared to previous occasions and to expectations, and then uses this information to adjust future incident response expectations and priorities. The pre-processing component 110 can use action success/completion and time taken as measures of improvement. Likewise, the cyberattack restoration engine 160 can use unsupervised machine learning algorithms to self-learn from previous cyber threat incidents to get better at healing the system being protected to mitigate the cyber threat while minimizing an impact on the system being protected. Likewise, the cyberattack restoration engine 160 also can use one or more unsupervised machine learning algorithms, as a self-learning entity, to have an ability to learn how to restore the one or more nodes in the graph of the protected system back to the trusted operational state while still mitigating against the cyber threat so the cyberattack restoration engine 160 learns from previous restoration attempts (e.g. action success/completion and time taken as measures, action effectiveness as a measure, etc., as well as including or adapting changes to previous recommendations made by the human security team).

The cyber threat detection engine 130, the autonomous response engine 140 and the cyberattack simulation engine 150 all perform their machine-learned task and send inputs to each other to assist in determining what nodes are impacted, what cyber threat is causing the problems, and how the cyberattack likely occurred and will progress based upon possible mitigation and restoration actions taken so that the restoration engine can rely on the determinations by the Artificial Intelligence in those AI-based engines to provide the cyberattack restoration engine 160 with a starting point for figuring out what is the system being protected is trying to recover from and then a best way to restore the nodes in the system.

There are four discrete AI-based engines 130, 140, 150 and 160 working to achieve aims with their own machine learning approaches. Each separate AI engine contributes data that has been processed intelligently through machine learning approaches and then hands over the processed behavioral metrics to another AI engine which then performs its own individualized machine-learned task.

The cyberattack simulation engine 150 in conducting simulations can use the cyber threat analyst module 320 of the cyber threat detection engine 130 with external data input (e.g., crowdstrike) and cooperate with the cyber threat detection engine 130 to identify an infected patient zero and additional devices actually compromised and/or directly linked to devices actually compromised in need of remediation. The linked devices or the activity may not be directly visible to the detection engine alone and the external data input fills in the big picture. The cyberattack restoration engine 160, operating to restore the protected system, can potentially use the external data input that the system is receiving from third party integrations (e.g., from host-based agents from 3rd party vendors, antivirus and -based testing antivirus, etc.) to identify patient zero of the attack, identify, where the attack has happened and is happening, identify devices that the system reasonably believes are linked to the compromised entity, and recommend remediation or perform remediation via AI alone, and/or AI in combination with human assistance. The cyberattack restoration engine 160 can restore the protected system back to a state before a compromise (e.g., abnormalities started) by a cyber threat occurred to the protected system. The cyberattack restoration engine 160 restores nodes in the protected system to cyberattacks in progress—so heals in real time, as an attack happens, as well as can assist in healing after an attack has taken place.

The trusted operational state of a node can be an operational state for a date and time before the earliest detection of a possible compromise of a node in the graph (device and/or user account) plus a threshold buffer amount of time.

In an example, the cyber threat detection engine 130 can use historic IaaS data on virtual resource usage to identify errant virtual resources and the autonomous response engine 140 to spin down those resources or disable overactive microservices like lambdas. In another example, the detection engine can use historic IaaS data on virtual resource usage to understand when a client is undergoing some kind of DDOS and the autonomous response engine 140 acts to do scaling to handle the load until the overload is over. The restoration engine can recommend controlling the scaling when the system understands deliberate overloading of traffic is occurring and then bringing that scaling back down again to assist their service architectures to deal with situations when some cyber threat is trying to overload those systems to bring that customer down.

In another example, the cyberattack restoration engine 160 to restore the protected system can use historic source codebase information and modelling from the AI models in the detection engine for development to revert commits and code changes that potentially introduce bad or compromised code. The cyberattack restoration engine 160 to restore the protected system can also use historic records of a source code database information to find out when during the development of a product that the cyberattack occurred on the source code in order to restore the source code back to the state before the compromise occurred, as well as use historic code base analysis and understanding to identify supply chain and products vulnerable to bad code/compromised code and sending an update package/at least a notice to revert those products and further prevent the source code vulnerabilities from trickling down the supply chains from the vendor to the end user. Once file data of a cyber threat is identified, then that file data and its characteristics are captured in an inoculation package and then cascade that file information to each cybersecurity appliance in the fleet of cybersecurity appliances, and quarantine the identical and very similar files in order to remove them from all of the environments before anything can spread even more than it has via immediate remediation and also using the system's own inoculation data.

In an example, the autonomous response engine 140 can stop a device that is infected from connecting to other nodes. In addition, the autonomous response engine 140 can restrict reading and writing traffic and/or types of data/information being communicated in that traffic to restrict traffic movement and process activity to nodes close to an entity that the system thinks is performing erroneously or infected.

Referring still to FIG. 3, the autonomous response engine 140 is configured to use one or more Application Programming Interfaces to translate desired mitigation actions for nodes (devices, user accounts, etc.) into a specific language and syntax utilized by that device, user account, etc. from potentially multiple different vendors being protected in order to send the commands and other information to cause the desired mitigation actions to change, for example, a behavior of a detected threat of a user and/or a device acting abnormal to the normal pattern of life. The selected mitigation actions on the selected nodes minimize an impact on other parts of the system being protected (e.g., devices and users) that are i) currently active in the system being protected and ii) that are not in breach of being outside the normal behavior benchmark. The autonomous response engine 140 can have a discovery module to i) discover capabilities of each node being protected device and the other cybersecurity devices (e.g., firewalls) in the system being protected and ii) discover mitigation actions they can take to counter and/or contain the detected threat to the system being protected, as well as iii) discover the communications needed to initiate those mitigation actions.

For example, the autonomous response engine 140 cooperates and coordinates with an example set of network capabilities of various network devices. The network devices may have various capabilities such as identity management including setting user permissions, network security controls, firewalls denying or granting access to various ports, encryption capabilities, centralize logging, antivirus anti-malware software quarantine and immunization, patch management, etc., and also freeze any similar, for example, network activity, etc. triggering the harmful activity on the system being protected.

Accordingly, the autonomous response engine 140 will take an autonomous mitigation action to, for example, shutdown the device or user account, block login failures, perform file modifications, block network connections, restrict the transmission of certain types of data, restrict a data transmission rate, remove, or restrict user permissions, etc. The autonomous response engine 140 for an email system could initiate example mitigation actions to either remedy or neutralize the tracking link, when determined to be the suspicious covert tracking link, while not stopping every email entering the email domain with a tracking link, or hold the email communication entirely if the covert tracking link is highly suspicious, and also freeze any similar, for example, email activity triggering the harmful activity on the system being protected.

The autonomous response engine 140 has a default set of autonomous mitigation actions shown on its user interface that it knows how to perform when the different types of cyber threats are equal to or above a user configurable threshold posed by this type of cyber threat. The autonomous response engine 140 is also configurable in its user interface to allow the user to augment and change what type of automatic mitigation actions, if any, the autonomous response engine 140 may take when different types of cyber threats that are equal to or above the configurable level of threat posed by a cyber threat.

The autonomous response engine 140 can also reference its artificial intelligence trained to perform mitigation actions. Again, the autonomous response engine 140 has an administrative tool in its user interface to program/set what autonomous mitigation actions the autonomous response engine 140 can take, including types of mitigation actions and specific mitigation actions the autonomous response engine 140 is capable of, when the cyber-threat module in the detection engine indicates the threat risk parameter is equal to or above the actionable threshold, selectable by the cyber professional. The cyber professional can also indicate what types of mitigation actions can be performed for different users and parts of the system as well as what actions need the cyber professional to approve. Again, the autonomous response engine 140 can also reference a default library of mitigation actions, types of mitigation actions and specific mitigation actions the autonomous response engine 140 is capable of on a particular node.

Referring back to FIG. 6, the cyberattack simulation engine 150 using AI-based simulations is communicatively coupled to a cybersecurity appliance 105, an open source (OS) database server 690, an email system 696, one or more endpoint computing devices 691A-B, and an IT network system 692 with one or more entities, over one or more networks 691/692 in the system being protected.

The cyberattack simulation engine 150 with AI-based simulations is configured to integrate with the cybersecurity appliance 105 via cyberattack simulator interface 375 of FIG. 3 and cooperate with components within the cybersecurity appliance 105 installed and protecting the network from cyber threats by making use of outputs, data collected, and functionality from two or more of a data store, other modules, and one or more AI models already existing in the cybersecurity appliance 105.

The cyberattack simulation engine 150 may include a cyber threat generator module to generate many different types of cyber threats with the past historical attack patterns to attack the simulated system to be generated by the simulated attack module 650 that will digitally/virtually replicate the system being protected, such as a phishing email generator configured to generate one or more automated phishing emails to pentest the email defenses and/or the network defenses provided by the cybersecurity appliance 105. For example, the system being protected can be an email system and then the phishing email generator may be configured to cooperate with the trained AI models to customize the automated phishing emails based on the identified data points of the organization and its entities.

The email module and network module may use a vulnerability tracking module to track and profile, for example, versions of software and a state of patches and/or updates compared to a latest patch and/or update of the software resident on devices in the system/network. The vulnerability tracking module can supply results of the comparison of the version of software as an actual detected vulnerability for each particular node in the system being protected, which is utilized by the node exposure score generator and the cyberattack simulation engine 150 with AI-based simulations in calculating 1) the spread of a cyber threat and 2) a prioritization of remediation actions on a particular node compared to the other network nodes with actual detected vulnerabilities. The node exposure score generator is configured to also factor in whether the particular node is exposed to direct contact by an entity generating the cyber threat (when the threat is controlled from a location external to the system e.g., network) or the particular node is downstream of a node exposed to direct contact by the entity generating the cyber threat external to the network.

The node exposure score generator and the simulated attack module 650 in the cyberattack simulation engine 150 cooperate to run the one or more hypothetical simulations of an actual detected cyber threat incident and/or a hypothetical cyberattack incident to calculate the node paths of least resistance in the virtualized instance/modeled instance of the system being protected. The progress through the node path(s) of least resistance through the system being protected are plotted through the various simulated instances of components of the graph of the system being protected until reaching a suspected end goal of the cyberattack scenario, all based on historic knowledge of connectivity and behavior patterns of users and devices within the system under analysis. The simulated attack module 650, via a simulator and/or a virtual network clone creator, can be programmed to model and work out the key paths and devices in the system (e.g., a network, with its nets and subnets,) via initially mapping out the system being protected and querying the cybersecurity appliance on specific's known about the system being protected by the cybersecurity appliance 105. The simulated attack module 650 is configured to search and query, two or more of i) a data store, ii) modules in the detection engine, and iii) the one or more Artificial Intelligence (AI) models making up the cybersecurity appliance 105 protecting the actual network under analysis from cyber threats, on what, i) the data store, ii) the modules, and iii) the one or more AI models in the cybersecurity appliance 105, already know about the nodes of the system, under analysis to create the graph of nodes of the system being protected. Thus, the cyberattack simulation engine 150 with AI-based simulations is configured to construct the graph of the virtualized version of the system from knowledge known and stored by modules, a data store, and one or more AI models of the cybersecurity appliance 105 protecting an actual network under analysis. The knowledge known and stored is obtained at least from ingested traffic from the actual system under analysis. Thus, the virtualized system, and its node components/accounts connecting to the network, being tested during the simulation are up to date and accurate for the time the actual system under analysis is being tested and simulated because the cyberattack simulation engine 150 with AI-based simulations is configured to obtain actual network data collected by two or more of 1) modules, 2) a data store, and 3) one or more AI models of a cybersecurity appliance protecting the actual network under analysis from cyber threats. The simulated attack module 650 will make a model incorporating the actual data of the system through the simulated versions of the nodes making up that system for running simulations on the simulator. Again, a similar approach is taken when the simulated attack module 650 uses a clone creator to spin up and create a virtual clone of the system being protected with virtual machines in the cloud.

The cyberattack simulation engine 150 with AI-based simulations is configured to simulate the compromise of a spread of the cyber threat being simulated in the simulated cyberattack scenario, based on historical and/or similar cyber threat attack patterns, between the devices connected to the virtualized network, via a calculation on an ease of transmission of the cyber threat algorithm, from 1) an originally compromised node by the cyber threat, 2) through to other virtualized/simulated instances of components of the virtualized network, 3) until reaching a suspected end goal of the cyberattack scenario, including key network devices. The cyberattack simulation engine 150 with AI-based simulations also calculates how likely it would be for the cyberattack to spread to achieve either of 1) a programmable end goal of that cyberattack scenario set by a user, or 2) set by default an end goal scripted into the selected cyberattack scenario.

The email module and the network module can include a profile manager module. The profile manager module is configured to maintain a profile tag on all of the devices connecting to the actual system/network under analysis based on their behavior and security characteristics and then supply the profile tag for the devices connecting to the virtualized instance of the system/network when the construction of the graph occurs. The profile manager module is configured to maintain a profile tag for each device before the simulation is carried out; and thus, eliminates a need to search and query for known data about each device being simulated during the simulation. This also assists in running multiple simulations of the cyberattack in parallel.

The cyberattack simulation engine 150 with AI-based simulations module is configured to construct the graph of the virtualized system, e.g. a network with its nets and subnets, where two or more of the devices connecting to the virtualized network are assigned with different weighting resistances to malicious compromise from the cyberattack being simulated in the simulated cyberattack scenario based on the actual cyberattack on the virtualized instance of the network and their node vulnerability score. In addition to a weighting resistance to the cyberattack, the calculations in the model for the simulated attack module 650 factor in the knowledge of a layout and connection pattern of each particular network device in a network, an amount of connections and/or hops to other network devices in the network, how important a particular device (a key importance) determined by the function of that network device, the user(s) associated with that network device, and the location of the device within the network. Note, multiple simulations can be conducted in parallel by the orchestration module. The simulations can occur on a periodic regular basis to pentest the cybersecurity of the system and/or in response to a detected ongoing cyberattack in order to get ahead of the ongoing cyberattack and predict its likely future moves. Again, the graph of the virtualize instance of the system is created with two or more of 1) known characteristics of the network itself, 2) pathway connections between devices on that network, 3) security features and credentials of devices and/or their associated users, and 4) behavioral characteristics of the devices and/or their associated users connecting to that network, which all of this information is obtained from what was already know about the network from the cybersecurity appliance.

During an ongoing cyberattack, the simulated attack module 650 is configured to run the one or more hypothetical simulations of the detected cyber threat incident and feed details of a detected incident by a cyber threat module in the detection engine into the collections module of the cyberattack simulation engine 150 using AI-based simulations. The simulated attack module 650 is configured to run one or more hypothetical simulations of that detected incident in order to predict and assist in the triggering an autonomous response by the autonomous response engine 140 and then restoration by the restoration engine to the detected incident.

The simulated attack module 650 ingests the information for the purposes of modeling and simulating a potential cyberattacks against the network and routes that an attacker would take through the network. The simulated attack module 650 can construct the graph of nodes with information to i) understand an importance of network nodes in the network compared to other network nodes in the network, and ii) to determine key pathways within the network and vulnerable network nodes in the network that a cyberattack would use during the cyberattack, via modeling the cyberattack on at least one of 1) a simulated device version and 2) a virtual device version of the system being protected under analysis. Correspondingly, the calculated likelihood of the compromise and timeframes for the spread of the cyberattack is tailored and accurate to each actual device/user account (e.g., node) being simulated in the system because the cyberattack scenario is based upon security credentials and behavior characteristics from actual traffic data fed to the modules, data store, and AI models of the cybersecurity appliance.

The cyberattack simulation engine 150 with its Artificial Intelligence trained on how to conduct and perform cyberattack in a simulation in either a simulator or in a clone creator spinning up virtual instances on virtual machines will take a sequence of actions and then evaluate the actual impact after each action in the sequence, in order to yield a best possible result to contain/mitigate the detected threat while minimizing the impact on other network devices and users that are i) currently active and ii) not in breach, from different possible actions to take. Again, multiple simulations can be run in parallel so that the different sequences of mitigation actions and restoration actions can be evaluated essentially simultaneously. The cyberattack simulation engine 150 with AI-based simulations is configured to use one or more mathematical functions to generate a score and/or likelihood for each of the possible actions and/or sequence of multiple possible actions that can be taken in order to determine which set of actions to choose among many possible actions to initiate. The one or more possible actions to take and their calculated scores can be stacked against each other to factor 1) a likelihood of containing the detected threat acting abnormal with each possible set of actions, 2) a severity level of the detected threat to the network, and 3) the impact of taking each possible set of actions i) on users and ii) on devices currently active in the network not acting abnormal to the normal behavior of the network, and then communicate with the cyber threat detection engine, the autonomous response engine 140, and the cyberattack restoration engine 160, respectively, to initiate the chosen set of actions to cause a best targeted change of the behavior of the detected threat acting abnormal to the normal pattern of life on the network while minimizing the impact on other network devices and users that are i) currently active and ii) not in breach of being outside the normal behavior benchmark. The cyberattack simulation engine 150 cooperates with the AI model(s) 687 modelling a normal pattern of life for entities/nodes in the system being protected.

The simulated attack module 650 is programmed itself and can cooperate with the artificial intelligence in the restoration engine to factor an intelligent prioritization of remediation actions and which nodes (e.g., devices and user accounts) in the simulated instance of the system being protected should have a priority compared to other nodes. This can also be reported out to assist in allocating human security team personnel resources that need human or human approval to restore the nodes based on results of the one or more hypothetical simulations of the detected incident.

Note, the cyberattack simulation engine 150, when doing attack path modelling, does not need to not calculate every theoretically possible path from the virtualized instance of the source device to the end goal of the cyberattack scenario but rather a set of the most likely paths, each time a hop is made from one node in the virtualized network to another device in the virtualized network, in order to reduce an amount of computing cycles needed by the one or more processing units as well as an amount of memory storage needed in the one or more non-transitory storage mediums.

FIG. 8 illustrates a block diagram of an embodiment of the cybersecurity appliance 105 with the cyber threat detection engine 130 and other AI-based engines communicatively coupled and collectively operating to protect an enterprise 800 is shown. The probes and detectors monitor, in this example, email activity and IT network activity to feed this data to determine what is occurring in each domain individually to their respective modules configured and trained to understand that domain's information as well as correlate causal links between these activities in these domains to supply this input into the modules of the cybersecurity appliance 105. The network can include various computing devices such as desktop units, laptop units, smart phones, firewalls, network switches, routers, servers, databases, Internet gateways, etc.

Herein, one or more computing devices 810 within the enterprise 800 can use the cybersecurity appliance 105 to detect and thereby attempt to prevent threats to computing devices within its bounds. In this exemplary embodiment, the cybersecurity appliance 105 with the multiple AI-based engines may be implemented on a computing device 820. The computing device 820 features the electronic hardware, modules, models, and various software processes of the cybersecurity appliance 105; and therefore, runs threat detection for detecting threats associated with the enterprise 800. As such, the computing device 820 includes one or more processors arranged to run the steps of the process described herein, memory storage components required to store information related to the running of the process, as well as a network interface for collecting the required information for the probes and other sensors collecting data from the network under analysis.

The cybersecurity appliance 105 in the computing device 820 builds and maintains a dynamic, ever-changing model of the ‘normal behavior’ of each user and machine within the system. The approach is based on Bayesian mathematics, and monitors all interactions, events, and communications within the system-which computer is talking to which, files that have been created, networks that are being accessed.

For example, a computing device 830 is based in a company's San Francisco office and operated by a marketing employee who regularly accesses the marketing network, usually communicates with machines in the company's U.K. office in second computer system 40 between 9.30 AM and midday and is active from about 8:30 AM until 12 PM. The same employee virtually never accesses the employee time sheets, very rarely connects to the company's Atlanta network, and has no dealings in South-East Asia. The cybersecurity appliance 105 takes all the information that is available relating to this employee and establishes a ‘pattern of life’ for that person and the devices used by that person in that system, which is dynamically updated as more information is gathered. The model of the normal pattern of life for an entity in the network under analysis is used as a moving benchmark, allowing the cybersecurity appliance 105 to spot behavior on a system that seems to fall outside of this normal pattern of life, and flags this behavior as anomalous, requiring further investigation and/or autonomous action.

The cybersecurity appliance 105 is built to deal with the fact that today's attackers are getting stealthier, and an attacker/malicious agent may be ‘hiding’ in a system to ensure that they avoid raising suspicion in an end user, such as by slowing their machine down. The AI model(s) deployed within or accessible to the cybersecurity appliance 105 builds a sophisticated ‘pattern of life’—that understands what represents normality for every person, device, and network activity in the system being protected by the cybersecurity appliance 105.

The self-learning AI algorithms can, for example, understand each node's (user account, device, etc.) in an organization's normal patterns of life in about a week, and grows more bespoke with every passing minute. Conventional AI typically relies solely on identifying threats based on historical attack data and reported techniques, requiring data to be cleansed, labelled, and moved to a centralized repository. The AI-based cyber threat detection engine 130 deployed within the cybersecurity appliance 105 operates as a self-learning Artificial Intelligence, which can learn “on the job” from real-world data occurring in the enterprise 800 and constantly evolves its understanding as the enterprise's environment changes. The Artificial Intelligence can use machine learning algorithms to analyze patterns and ‘learn’ what is the ‘normal behavior’ of the network by analyzing data on the activity on the network at the device and employee level. The unsupervised machine learning does not need humans to supervise the learning in the model but rather discovers hidden patterns or data groupings without the need for human intervention. The unsupervised machine learning discovers the patterns and related information using the unlabeled data monitored in the system itself. Unsupervised learning algorithms can include clustering, anomaly detection, neural networks, etc. Unsupervised learning algorithm can break down features of what it is analyzing (e.g., a network node of a device or user account), which can be useful for categorization, and then identify what else has similar or overlapping feature sets matching to what it is analyzing.

The cybersecurity appliance 105 can use unsupervised machine learning to works things out without pre-defined labels. In the case of sorting a series of different entities, such as animals, the cybersecurity appliance 105 analyzes the information and works out the different classes of animals. This allows the entire cybersecurity system to handle the unexpected and embrace uncertainty when new entities and classes are examined. The modules and models of the cybersecurity appliance 105 do not always know what they are looking for but can independently classify data and detect compelling patterns.

The cybersecurity appliance's 105 unsupervised machine learning methods do not require training data with pre-defined labels. Instead, they are able to identify key patterns and trends in the data, without the need for human input. The advantage of unsupervised learning in this system is that it allows computers to go beyond what their programmers already know and discover previously unknown relationships. The unsupervised machine learning methods can use a probabilistic approach based on a Bayesian framework. The machine learning allows the cybersecurity appliance 105 to integrate a huge number of weak indicators/low threat values by themselves of potentially anomalous network behavior to produce a single clear overall measure of these correlated anomalies to determine how likely a network device is to be compromised. This probabilistic mathematical approach provides an ability to understand important information, amid the noise of the network-even when it does not know what it is looking for.

The models in the cybersecurity appliance 105 can use a Recursive Bayesian Estimation to combine these multiple analyzes of different measures of network behavior to generate a single overall/comprehensive picture of the state of each device, the cybersecurity appliance 105 takes advantage of the power of Recursive Bayesian Estimation (RBE) via an implementation of the Bayes filter.

Using RBE, the AI model(s) utilized by the cybersecurity appliance 105 are able to constantly adapt themselves, in a computationally efficient manner, as new information becomes available to the system. Also, these AI model(s) continually recalculate threat levels in the light of new evidence, identifying changing attack behaviors where conventional signature-based methods fall down.

Training a model can be accomplished by having the model learn good values for all of the weights and the bias for labeled examples created by the system, and in this case, starting with no labels initially. A goal of the training of the model can be to find a set of weights and biases that have low loss, on average, across all examples.

The AI classifier can receive supervised machine learning with a labeled data set to learn to perform their task as discussed herein. An anomaly detection technique that can be used is supervised anomaly detection that requires a data set that has been labeled as “normal” and “abnormal” and involves training a classifier. Another anomaly detection technique that can be used is an unsupervised anomaly detection that detects anomalies in an unlabeled test data set under the assumption that the majority of the instances in the data set are normal, by looking for instances that seem to fit least to the remainder of the data set. The model representing normal behavior from a given normal training data set can detect anomalies by establishing the normal pattern and then test the likelihood of a test instance under analysis to be generated by the model. Anomaly detection can identify rare items, events or observations which raise suspicions by differing significantly from the majority of the data, which includes rare objects as well as things like unexpected bursts in activity.

The methods and systems shown in the figures and discussed in the text herein can be coded to be performed, at least in part, by one or more processing components with any portions of software stored in an executable format on a computer readable medium. Thus, any portions of the method, apparatus and system implemented as software can be stored in one or more non-transitory storage devices in an executable format to be executed by one or more processors. The computer readable medium may be non-transitory and does not include radio or other carrier waves. The computer readable medium could be, for example, a physical computer readable medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD. The various methods described above may also be implemented by a computer program product. The computer program product may include computer code arranged to instruct a computer to perform the functions of one or more of the various methods described above. The computer program and/or the code for performing such methods may be provided to an apparatus, such as a computer, on a computer readable medium or computer program product. For the computer program product, a transitory computer readable medium may include radio or other carrier waves.

Herein, certain terminology is used to describe aspects of the invention. For example, in certain situations, the terms “engine,” “logic,” “component,” “module,” and “element” are representative of hardware, firmware, or software that is configured to perform one or more functions. As hardware, engine (or logic/component/module/element) may include circuitry having data processing or storage functionality. Examples of such circuitry may include, but are not limited or restricted to, one or more hardware processors (e.g., a microprocessor with one or more processor cores, a digital signal processor, a programmable gate array, a microcontroller, an application specific integrated circuit “ASIC,” etc.), a semiconductor memory, or combinatorial elements.

Alternatively, the engine (or logic/component/module/element) may be software, such as executable code in the form of an executable application, a graphical user interface (GUI), an Application Programming Interface (API), a subroutine, a function, a procedure, an applet, a servlet, a routine, source code, object code, a shared library/dynamic library, or one or more instructions. The software may be stored in any type of a suitable non-transitory storage medium or transitory storage medium (e.g., electrical, optical, acoustical, or other forms of propagated signals such as carrier waves, infrared signals, or digital signals). Examples of the non-transitory storage medium may include, but are not limited or restricted to, a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device.

A “computing device” may be generally construed as electronics with data processing capability and/or a capability of connecting to any type of network, such as a public network (e.g., Internet), a private network (e.g., a wireless data telecommunication network, a local area network “LAN,” etc.), or a combination of networks. Examples of a computing device may include, but are not limited or restricted to, the following: a server, an endpoint device (e.g., a laptop, a smartphone, a tablet, a desktop computer, a netbook, networked wearable, or any general-purpose or special-purpose, user-controlled electronic device); a mainframe; a router; or the like. Hence, computing device can be, wholly or partially, part of one or more of the server or client computing devices in accordance with some embodiments. Components of the computing system can include, but are not limited to, a processing unit having one or more processing cores, a system memory, and a system bus that couples various system components including the system memory to the processing unit.

### Computing Devices

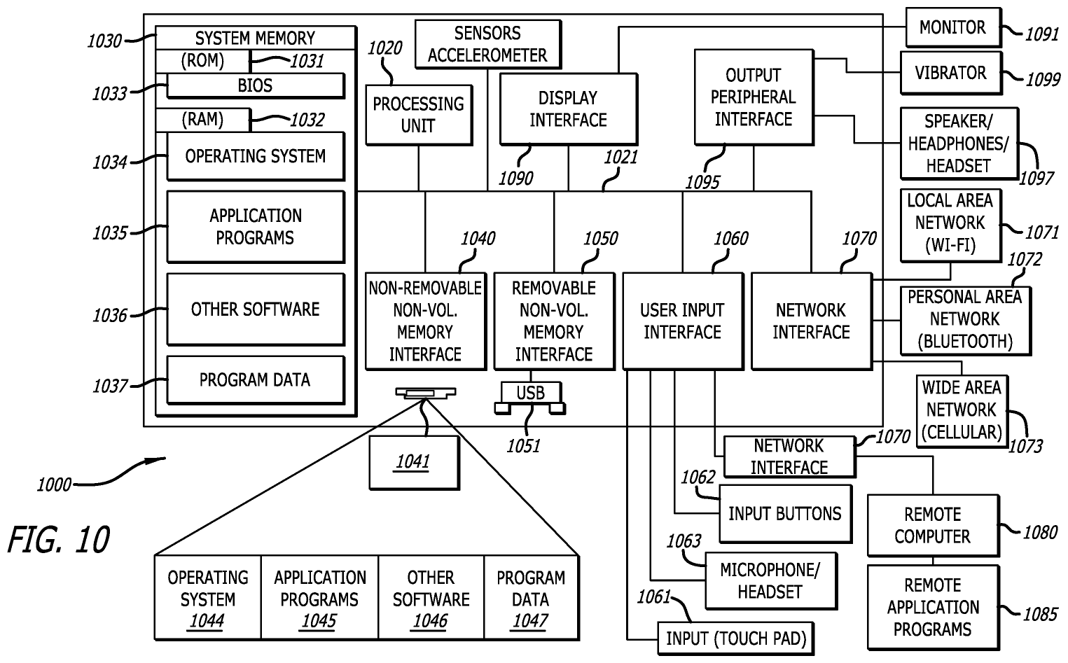

Referring to FIG. 10, an illustrative block diagram of an embodiment of one or more computing devices that can be a part of the AI-based cybersecurity system including the multiple AI-based engines is shown. The computing device 1000 may include one or more processors (hereinafter, “processing unit”) 1020 to execute instructions, one or more memories 1030-1032 to store information, one or more data input components 1060-1063 to receive data input from a user of the computing device 1000, one or more modules that include the management module, a network interface communication circuit 1070 to establish a communication link to communicate with other computing devices external to the computing device, one or more sensors where an output from the sensors is used for sensing a specific triggering condition and then correspondingly generating one or more preprogrammed actions, a display monitor 1091 to display at least some of the information stored in the one or more memories 1030-1032 and other components. Note, portions of this design implemented in software 1044, 1045, 1046 are stored in the one or more memories 1030-1032 and are executed by the processing unit 1020. The processing unit 1020 may have one or more processing cores, which couples to a system bus 1021 that couples various system components including the system memory 1030. The system bus 1021 may be any of several types of bus structures selected from a memory bus, an interconnect fabric, a peripheral bus, and a local bus using any of a variety of bus architectures.

Computing device 1000 typically includes a variety of computing machine-readable media. Machine-readable media can be any available media that can be accessed by computing device 1000 and includes both volatile and nonvolatile media, and removable and non-removable media. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information, and which can be accessed by the computing device 1000. Transitory media such as wireless channels are not included in the machine-readable media. Machine-readable media typically embody computer readable instructions, data structures, and other executable software. In an example, a volatile memory drive 1041 is illustrated for storing portions of the operating system 1044, application programs 1045, other executable software 1046, and program data 1047.

A user may enter commands and information into the computing device 1000 through input devices such as a keyboard, touchscreen, or software or hardware input buttons 1062, a microphone 1063, a pointing device and/or scrolling input component, such as a mouse, trackball, or touch pad 1061. The microphone 1063 can cooperate with speech recognition software. These and other input devices are often connected to the processing unit 1020 through a user input interface 1060 that is coupled to the system bus 1021 but can be connected by other interface and bus structures, such as a lighting port, game port, or a universal serial bus (USB). The display monitor 1091, or other type of display screen device, is also connected to the system bus 1021 via an interface, such as a display interface 1090. In addition to the monitor 1091, computing devices may also include other peripheral output devices such as speakers 1097, a vibration device 1099, and other output devices, which may be connected through an output peripheral interface 1095.

The computing device 1000 can operate in a networked environment using logical connections to one or more remote computers/client devices, such as a remote computing device 1080. The remote computing device 1080 may include a personal computer, a mobile computing device, a server, a router, a network PC, a peer device, or other common network node, and typically includes many or all of the elements described above relative to the computing device 1000. The logical connections can include a personal area network (PAN) 1072 (e.g., Bluetooth®), a local area network (LAN) 1071 (e.g., Wi-Fi), and a wide area network (WAN) 1073 (e.g., cellular network). Such networking environments are commonplace in offices, enterprise-wide computer networks, intranets, and the Internet. A browser application and/or one or more local apps may be resident on the computing device and stored in the memory.

When used in a LAN networking environment, the computing device 1000 is connected to the LAN 1071 through the network interface communication circuit 1070, which can be, for example, a Bluetooth® or Wi-Fi adapter. When used in a WAN networking environment (e.g., Internet), the computing device 1000 typically includes some means for establishing communications over the WAN 1073. With respect to mobile telecommunication technologies, for example, a radio interface, which can be internal or external, can be connected to the system bus 1021 via the network interface communication circuit 1070, or other appropriate mechanism. In a networked environment, other software depicted relative to the computing device 1000, or portions thereof, may be stored in the remote memory storage device. By way of example, and not limitation, remote application programs 1085 as reside on remote computing device 1080. It will be appreciated that the network connections shown are examples and other means of establishing a communications link between the computing devices that may be used. It should be noted that the present design can be carried out on a single computing device or on a distributed system in which different portions of the present design are carried out on different parts of the distributed computing system.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A software engine is a core component of a complex system consisting of hardware and software that is capable of performing its function discretely from other portions of the entire complex system but designed to interact with the other portions of the entire complex system.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

In certain instances, the terms “compare,” comparing,” “comparison,” or other tenses thereof generally mean determining if a match (e.g., a certain level of correlation ranging from an identical to a partial match such as 70% matching for example) is achieved between two items. These items may include particular patterns of information.

Additionally, the term “message” generally refers to information transmitted in one or more electrical signals that collectively represent electrically stored data in a prescribed format. Each message may be in the form of one or more packets, frames, HTTP-based transmissions, or any other series of bits having the prescribed format. The message may include a “prompt,” namely a piece of text or code that serves as input for generative AI logic such as a large language model (LLM) for example.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A method for enhancing detection of cyber threats by a cybersecurity system through use of one or more Large Language Models (LLMs), the method comprising:
generating a first embedding vector based on content within a first data set, wherein the first data set includes at least a first user credential;
generating a second embedding vector based on content within a second data set, wherein the second data set includes at least a second user credential;
based on a level of correlation between the first embedding vector and the second embedding vector exceeding a prescribed value, identifying a user is associated with both the first user credential and the second user credential; and
training an Artificial Intelligence (AI) model using both the content within the first data set and the content within the second data set to improve detection of cyber threats associated with data pertaining to the user.

2. The method of claim 1, wherein prior to generating the first embedding vector and the second embedding vector, the method further comprising:
receiving data from external sources, wherein the received data comprises at least (i) the first data set including the first user credential followed by the second data set including the second user credential.

3. The method of claim 2, wherein the external source comprises open-source cyber threat intelligence, social media information, and news website information.

4. The method of claim 2, wherein the AI model is configured to conduct analytics on the received data and pattern of life data associated with the user that increases a likelihood of identifying cyber threats associated with the received data based on detection of anomalous behaviors by the user.

5. The method of claim 1, further comprising:
uploading a prompt to a first LLM of the one or more LLMs that is configured to (i) generate the first embedding vector, (ii) generate the second embedding vector, (iii) identify whether the user is associated with both the first user credential and the second user credential, and controlling the training of the AI model utilizing the content within the first data set and the content within the second data set.

6. The method of claim 1, further comprising:
removing sensitive information including personally identifiable information (PII) data from the first data set prior to generating of the first embedding vector and removing sensitive information including PII data from the second data set prior to generating of the second embedding vector.

7. The method of claim 1, further comprising:
generating one or more structured elements, each operating as a complex filter for extracting salient data from first data set and the second data set to facilitate integration of the content of the second data set to improve or expand cyber threat detection functionality.

8. A non-transitory computer readable medium comprising computer readable code operable, when executed by one or more processing apparatuses in a computer system to instruct a computing device to perform the method of claim 1.

9. A cybersecurity system, comprising:
a first large language model (LLM) configured, upon execution, to generate one or more structured elements that operate as a complex filter for automatically extracting salient data from data received from one or more external sources for training of one or more Artificial Intelligence (AI) models;
a second LLM configured, upon execution, to correlate multiple user credentials associated with different platforms to a common user to enhance training of the one or more AI models formerly trained with data associated with the common user as identified by a first user credential with additional data associated with a second user credential to enhance cyber threat analytics pertaining to activities by the common user;
a third LLM configured, upon execution, to anonymize at least personally identifiable information (PII) data prior to training of the one or more AI models; and
where instructions implemented in software for the first LLM, the second LLM, and the third LLM are configured to be stored in one or more non-transitory storage mediums to be executed by one or more processing units.

10. The cybersecurity system of claim 9, wherein the second LLM is configured to correlate the multiple user credentials by at least
receiving data from the one or more external sources, wherein the received data comprises at least (i) a first data set including the first user credential followed by a second data set including the second user credential;
generating a first embedding vector based on content within the first data set;
generating a second embedding vector based on content within the second data set;
identifying the common user being associated with both the first user credential and the second user credential in response to the second LLM detecting at least a prescribed level of correlation between the first embedding vector and the second embedding vector; and
training an AI model of the one or more AI models using both the content within the first data set and the content within the second data set to improve detection of cyber threats associated with data pertaining to the common user.

11. The cybersecurity system of claim 10, wherein the one or more external sources comprises open-source cyber threat intelligence, social media information, and news website information.

12. The cybersecurity system of claim 10, wherein the AI model is configured to conduct analytics on the received data and pattern of life data associated with the user that increases a likelihood of identifying cyber threats associated with the received data based on detection of anomalous behaviors by the user.

13. A non-transitory storage medium including one or more large language models configured, when processed by one or more processors, to perform operations comprising:
generating a first embedding vector based on content within a first data set, wherein the first data set includes at least a first user credential;
generating a second embedding vector based on content within a second data set, wherein the second data set includes at least a second user credential;
based on a level of correlation between the first embedding vector and the second embedding vector exceeding a prescribed value, identifying a user is associated with both the first user credential and the second user credential; and
training an Artificial Intelligence (AI) model using both the content within the first data set and the content within the second data set to improve detection of cyber threats associated with data pertaining to the user.

14. The non-transitory storage medium of claim 13, wherein the one or more large language models, prior to generating the first embedding vector and the second embedding vector, are further configured to receive data from external sources, wherein the received data comprises at least (i) the first data set including the first user credential followed by the second data set including the second user credential.

15. The non-transitory storage medium of claim 14, wherein the AI model is configured to conduct analytics on the received data and pattern of life data associated with the user that increases a likelihood of identifying cyber threats associated with the received data based on detection of anomalous behaviors by the user.

16. The non-transitory storage medium of claim 13, wherein the one or more large language models are further configured to remove sensitive information including personally identifiable information (PII) data from the first data set prior to generating of the first embedding vector and removing sensitive information including PII data from the second data set prior to generating of the second embedding vector.

17. The non-transitory storage medium of claim 13, wherein the one or more large language models are further configured to generate one or more structured elements, each of the one or more structured elements operating as a complex filter for extracting salient data from first data set and the second data set to facilitate integration of the content of the second data set to improve or expand cyber threat detection functionality.
